(19) United States
(12) Patent Application Publication
(10) Pub. No.: US 2019/0286973 A1
(43) Pub. Date: Sep. 19, 2019

(54) HARDWARE ACCELERATED NEURAL NETWORK SUBGRAPHS

(71) Applicant: Microsoft Technology Licensing, LLC, Redmond, WA (US)

(72) Inventors: Ratna Kumar Kovvuri, Bothell, WA (US); Ahmad Mahdi El Husseini, Kirkland, WA (US); Steven K. Reinhardt, Vancouver, WA (US); Daniel Lo, Bothell, WA (US); Eric S. Chung, Woodinville, WA (US); Sarabjit Singh Seera, Redmond, WA (US); Friedel van Megen, Wurselen (DE); Alessandro Forin, Bellevue, WA (US)

(73) Assignee: Microsoft Technology Licensing, LLC, Redmond, WA (US)

(21) Appl. No.: 15/971,850

(22) Filed: May 4, 2018

Related U.S. Application Data
(60) Provisional application No. 62/643,097, filed on Mar. 14, 2018.

(51) Int. Cl. G06N 3/063; G06N 3/08

(52) U.S. Cl. CPC G06N 3/063; G06N 3/0445; G06N 3/08

(57) ABSTRACT

Technology related to hardware accelerated neural network subgraphs is disclosed. In one example of the disclosed technology, a method includes receiving source code specifying a neural network model. The source code includes an application programming interface (API) marking a subgraph of the neural network model as targeted for hardware acceleration. The method includes compiling the subgraph to the neural network accelerator target to generate configuration information for the hardware accelerator. The method includes configuring the hardware accelerator to evaluate the neural network model, where the hardware accelerator is configured using the configuration information.

### CROSS-REFERENCE TO RELATED APPLICATIONS

This application claims the benefit of U.S. Provisional Application No. 62/643,097, entitled “HARDWARE ACCELERATED NEURAL NETWORK SUBGRAPHS,” filed Mar. 14, 2018, the entire disclosure of which is incorporated herein by reference in its entirety.

### BACKGROUND

Machine learning (ML) and artificial intelligence (AI) techniques can be useful for solving a number of complex computational problems such as recognizing images and speech, analyzing and classifying information, and performing various classification tasks. Machine learning is a field of computer science that uses statistical techniques to give computer systems the ability to extract higher level features from a set of training data. Specifically, the features can be extracted by training a model such as an artificial neural network (NN) or a deep neural network (DNN) using data that has already been classified, such as by human. After the model is trained, new data can be applied to the model and the new data can be classified (e.g., higher level features can be extracted) using the trained model. Machine learning models are typically executed on a general-purpose processor (also referred to as a central processing unit (CPU)). However, the models can be computationally expensive and so it may not be possible to perform feature extraction in real-time using general-purpose processors. It can be desirable to perform real-time classification for applications such as defect analysis for products moving on an assembly line and in human-computer interactions, for example.

### SUMMARY

In some examples of the disclosed technology, a method includes receiving source code specifying a neural network model. The source code includes an application programming interface (API) marking a subgraph of the neural network model as targeted for hardware acceleration. The method includes compiling the subgraph to the neural network accelerator target to generate configuration information for the hardware accelerator. The method includes configuring the hardware accelerator to evaluate the neural network model, where the hardware accelerator is configured using the configuration information.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The foregoing and other objects, features, and advantages of the disclosed subject matter will become more apparent from the following detailed description, which proceeds with reference to the accompanying figures.

### BRIEF DESCRIPTION OF THE DRAWINGS

FIG. 1 is a block diagram of a neural network multiprocessor, as can be implemented in some examples of the disclosed technology.

FIG. 2 illustrates a simplified topology of an example deep neural network (DNN) that can be used to perform enhanced image processing using certain examples of the disclosed technology.

FIG. 3A is a diagram illustrating a high level of abstraction of a neural network model including a subgraph that can be accelerated on a neural network accelerator, as can be used in certain examples of the disclosed technology.

FIG. 3B is a flow chart outlining an example method of using a neural network model, such as the neural network model of FIG. 3A.

FIG. 4 is a diagram illustrating an example of a neural network server coupled to a neural network accelerator, as can be implemented in certain examples of the disclosed technology.

FIG. 5A is a diagram depicting an example of a neural network model and a subgraph that can be mapped to a hardware accelerator for evaluation of that portion of the neural network.

FIG. 5B is a diagram depicting additional examples of the subgraph from FIG. 5A that can be mapped to a hardware accelerator for evaluation of that portion of the neural network.

FIG. 6 is a block diagram that depicts an example field programmable gate array (FPGA) architecture that is configured to implement certain examples of the disclosed technology.

FIG. 7 is a block diagram illustrating an example of reconfigurable logic blocks that can configured to form part of a logic fabric of an example FPGA-integrated circuit.

FIGS. 8-10 provide example pseudo-code for an API that can be used to specify interface connections between a neural network model and a subgraph.

FIG. 11 is a flow chart outlining an example method of using a partitioned neural network model, as can be performed in certain examples of the disclosed technology.

FIG. 12 is a flow chart outlining an example method of using a neural network model, as can be performed in certain examples of the disclosed technology.

FIG. 13 is a flow chart outlining an example method of using a neural network model, as can be performed in certain examples of the disclosed technology.

FIG. 14 is a block diagram illustrating a suitable computing environment for implementing some embodiments of the disclosed technology.

### DETAILED DESCRIPTION

Machine learning models can be accelerated using hardware accelerators. A hardware accelerator includes configurable and/or pre-configured hardware that is customized to perform a specific task. A neural network accelerator is a hardware accelerator that includes configurable and/or pre-configured hardware for performing neural network operations, such as calculating a dot product, calculating an activation function, and/or broadcasting tensor values to neural nodes in parallel. A pre-configured or full-custom hardware design may perform classification tasks at a high rate of performance However, the development costs and the evolving nature of machine learning techniques make full-custom hardware designs impractical for most classification tasks. A hybrid approach using a general-purpose processor coupled to a graphics processor unit (GPU) and/or with programmable hardware can provide a speed-up over a general-purpose processor by itself. The hardware accelerator (e.g., the GPU and/or the programmable hardware) can potentially accelerate performance for tasks that are executed on the accelerator, but the communication costs between the general-purpose CPU and the hardware accelerator may reduce or eliminate any gains provided by the accelerator. For example, some portions of the machine learning model may have a high proportion of data movement to computation whereas other portions of the model may have a high proportion of computation to data movement. The more computationally-intensive portions may be more well-suited for hardware acceleration and the less computationally intensive portions may be more well-suited for the general-purpose CPU. Thus, a solution that provides for general acceleration of a machine learning model, but that does not have any control over which subgraphs are accelerated, may not perform as well as a solution where individual subgraphs can be selected for acceleration.

As described herein, a machine learning model can include a graph of computational nodes. The machine learning model can be partitioned into different subgraphs, where each of the subgraphs comprises a subset of the computational nodes of the machine learning model. Each of the subgraphs can be executed by either a CPU, a GPU, or programmable hardware. Specifically, the target hardware for executing each of the subgraphs can be identified using a programming interface, an application programming interface, and/or marker nodes. The hardware used to execute the subgraphs can be selected based on the suitability of the subgraph for the particular hardware. As an example, the less computationally intensive portions can be executed on the CPU and the more computationally intensive portions can be executed on the programmable hardware. By enabling the most appropriate hardware to execute a given subgraph, a system can potentially have higher performance than systems where the individual subgraphs are not individually assignable to different types of hardware. It should be noted that one class of machine learning models is a neural network model.

Methods and apparatus are disclosed for partitioning artificial neural network (NN) models, including deep neural network (DNN), into subgraphs that can be provided to a neural network accelerator, therefore providing improved processing speed and reduced latency. In some examples, a neural network model includes a plurality of interconnected neural nodes, where each neural node has associated weights and/or bias(es). Each of the neural nodes provides an output as a function of the weights and biases. In some examples, the output is a function of the dot product with the node weights multiplied with its input values plus a bias value. A number of edges connect the NN nodes, in a variety of topologies. In some examples, some of the nodes are recurrent nodes that provide output as a function of input plus a previous output of the node (e.g., gated recurrent unit (GRUs) nodes or long short-term memory (LSTM) nodes). Generally, subgraphs containing recurrent nodes can be more computationally intensive than similar sized feed-forward subgraphs that have no feedback.

Examples of suitable applications for such neural network models include, but are not limited to: performing image recognition, performing speech recognition, artificial intelligence, classifying images, translating speech to text and/or to other languages, facial or other biometric recognition, natural language processing, automated language translation, query processing in search engines, automatic content selection, analyzing email and other electronic documents, relationship management, biomedical informatics, identifying candidate biomolecules, providing recommendations, or other classification tasks. In some examples of the disclosed technology, a system includes hardware for implementing neural networks. The hardware can include, but is not limited to, general-purpose processors (including processors implementing vector instruction sets), custom integrated circuits, application-specific integrated circuits (ASICs), programmable logic devices including field programmable gate arrays (FPGAs), graphics processing units (GPUs), neural networking processors, and/or digital signal processing components.

I. General Considerations

This disclosure is set forth in the context of representative embodiments that are not intended to be limiting in any way.

As used in this application the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

The systems, methods, and apparatus described herein should not be construed as being limiting in any way. Instead, this disclosure is directed toward all novel and non-obvious features and aspects of the various disclosed embodiments, alone and in various combinations and subcombinations with one another. The disclosed systems, methods, and apparatus are not limited to any specific aspect or feature or combinations thereof, nor do the disclosed things and methods require that any one or more specific advantages be present or problems be solved. Furthermore, any features or aspects of the disclosed embodiments can be used in various combinations and subcombinations with one another.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “produce,” “generate,” “perform,” “select,” “receive,” “emit,” “verify,” “execute,” and “initiate” to describe the disclosed methods. These terms are high-level descriptions of the actual operations that are performed. The actual operations that correspond to these terms will vary depending on the particular implementation and are readily discernible by one of ordinary skill in the art having the benefit of the present disclosure.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Any of the disclosed methods can be implemented as computer-executable instructions stored on one or more computer-readable media (e.g., computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques, as well as any data created and used during implementation of the disclosed embodiments, can be stored on one or more computer-readable media (e.g., computer-readable storage media). The computer-executable instructions can be part of, for example, a dedicated software application, or a software application that is accessed or downloaded via a web browser or other software application (such as a remote computing application). Such software can be executed, for example, on a single local computer (e.g., with general-purpose and/or specialized processors executing on any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C, C++, Java, or any other suitable programming language. Likewise, the disclosed technology is not limited to any particular computer or type of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

II. Introduction to the Disclosed Technologies

Neural networks (NNs) are applied to a number of applications in Artificial Intelligence including image recognition, speech recognition, search engines, and other suitable applications. The processing for these applications may take place on individual devices such as personal computers or cell phones, but it may also be performed in large datacenters. At the same time, Field Programmable Gate Arrays (FPGAs) are being deployed into data centers due to their flexible nature and low power consumption per unit computation.

Computer hardware to implement neural networks is not limited to general-purpose microprocessors. Indeed, specialized hardware such as FPGAs, digital signal processors, graphics processing units, or specialized neural network processors can be used implement neural network processing. Such specialized hardware thus acts as a hardware accelerator for neural networks. However, adapting neural networks and associated programming models to such specialized hardware is difficult.

In some examples of the disclosed technology, a compiler is provided to partition a DNN model into a number of subgraphs. One or more, or all of the subgraphs can be run using specialized hardware to provide acceleration. Other subgraphs that are not mapped to specialized hardware can be implemented using a general-purpose processor. Depending on a particular application, inputs, outputs, and content of a sub-graph partition may vary significantly, depending on a number of different factors. In some examples of the disclosed technology, loading and execution of selected DNN subgraphs can be performed with low overhead using a compiler that generates metadata and code for specialized hardware accelerators.

According to one aspect of the disclosed technology, an ability to load DNN subgraphs having arbitrary boundaries onto hardware accelerators is provided. This can include initializing static storage with model weights and biases for the DNN model. According to another aspect of the disclosed technology, an input payload is prepared at runtime, mapped to a DNN hardware accelerator, and allowed to execute subgraphs of a DNN model having arbitrary boundaries. Appropriate mapping and formatting of inputs and outputs, including the capability to the interface between a general-purpose processor at a hardware accelerator is provided.

In some examples of the disclosed technology, a compiler is provided to partition subgraphs from a DNN model for execution on acceleration hardware. The compiler generates metadata and code describing edges and nodes of the subgraphs. For example, model weights and biases for a previously-trained DNN model can be provided to a hardware accelerator. This enables such a hardware accelerator to host arbitrary DNN model subgraphs. In some examples, a runtime environment is provided that uses information about the subgraphs and information about the DNN model containing the parent graph to construct messages for calling the hardware-accelerated subgraphs. This allows the hardware accelerated subgraph to act as a single node in the parent model.

According to another aspect of the disclosed technology, an installer, which programs the specialized hardware accelerator, and a runtime environment can further optimize the subgraph, because they use code and metadata generated by a neural network compiler. Further, as just a portion of the overall model is provided for hardware acceleration, further optimization of the subgraph can be provided, as a smaller portion of the overall model is being mapped to the acceleration hardware. This allows higher return for optimization effort applied to the subgraph.

According to another aspect of the disclosed technology, a runtime environment for the specialized hardware accelerator does not need to have model-specific logic to be provided at execution time in order to be initialized or to invoke the hardware accelerator.

In some examples of the disclosed technology, alternate number formats can be used to represent node values, including weights, biases, and tensor values. For example, block floating point representations, where two or more mantissas, or an entire array or matrix, share a common exponent can be used. Wider integer or fixed-point formats, which are efficient on a general-purpose processor (e.g., 32-bit data) can be quantized to 16-, 8-, 5-, or another number of bits. Such representations may be particularly helpful where an FGPA is used to provide neural network hardware acceleration. One of the characteristics of computation on an FPGA device is that it typically lacks hardware floating-point support. Floating-point operations may be performed at a penalty using the flexible logic, but often the amount of logic needed to support floating-point is prohibitive in FPGA implementations. Some newer FPGAs have been developed that do support floating-point computation, but even on these the same device can produce twice as many computational outputs per unit time if it is used in an integer mode. Typically, NNs are created with floating-point computation in mind, but when an FPGA is targeted for NN processing it would be beneficial if the neural network could be expressed using integer arithmetic.

Block Floating-point (BFP) can be used to tradeoff precision and storage requirements, in a fashion that is similar in some respects to normal floating-point. First, rather than storing an exponent with every floating-point number, a group of numbers can share the same exponent. To share exponents while maintaining a high level of accuracy, the numbers should have close to the same magnitude, since differences in magnitude are expressed in the mantissa. If the differences in magnitude are too great, the mantissa will overflow for the large values, or may be zero (“underflow”) for the smaller values. Depending on a particular application, some amount of overflow and/or underflow may be acceptable.

Due to the reduced floating-point support on FPGAs, floating-point computations on the FPGAs may be performed at a lower precision than if the computations were performed on a general-purpose CPU. The differences in precision can potentially affect the training and evaluation of the neural network models, especially when different subgraphs of a given neural network model are performed using different hardware, where the different hardware supports different precisions. As disclosed herein, mixed-precision support can be provided for a neural network model. For example, the neural network model can be trained using computations with precisions that can increase a likelihood of convergence and/or increase a speed of convergence. Specifically, the neural network model can be initially trained using computations with a relatively high precision (e.g., at the precision of the general-purpose CPU). The training can be fine-tuned using computations where the precision matches the precision of the hardware executing each of the subgraphs. By fine-tuning the training, the accelerated neural network model may achieve more accurate results than if the training were not fine-tuned. Additionally, an effect of the lower precision hardware can be simulated prior to deployment of the neural network model on specialized hardware. The ability to test the trained neural network model prior to deploying on the specialized hardware can potentially reduce development time and/or development costs.

Neural network operations are used in many artificial intelligence operations. Often, the bulk of the processing operations performed in implementing a neural network is in performing Matrix×Matrix or Matrix×Vector multiplications. Such operations are compute- and memory-bandwidth intensive, where the size of a matrix may be, for example, 1000×1000 elements (e.g., 1000×1000 numbers, each including a sign, mantissa, and exponent) or larger and there are many matrices used. As discussed herein, techniques can be applied to such operations to reduce the demands for computation as well as memory bandwidth in a given system, whether it is an FPGA, CPU or another hardware platform. As used herein, the use of the term “element” herein refers to a member of such a matrix or vector.

Values for the matrices and the shared exponents can be stored in any suitable memory storage device. For example, the matrices and the shared exponents can be stored in an addressable memory (e.g., dynamic random access memory (DRAM, including DDR, DDR2, etc., DRAM), embedded DRAM (eDRAM), or static random access memory (SRAM), an array of latches, an array of flip-flops, a register file, a block random access memory (block RAM) (sometimes called “memory blocks”), a First-In First Out (FIFO) buffer, or a shift register. In some examples, values for the matrices are stored in an addressable memory or register file and values for the shared exponents are stored in a number of flip-flops or latches. Thus, allocating a full memory to store data for the shared exponents may be avoided. In some examples, storage such as flip-flops or registers are allocated to store values for shared exponents.

III. Example Neural Network Multiprocessor

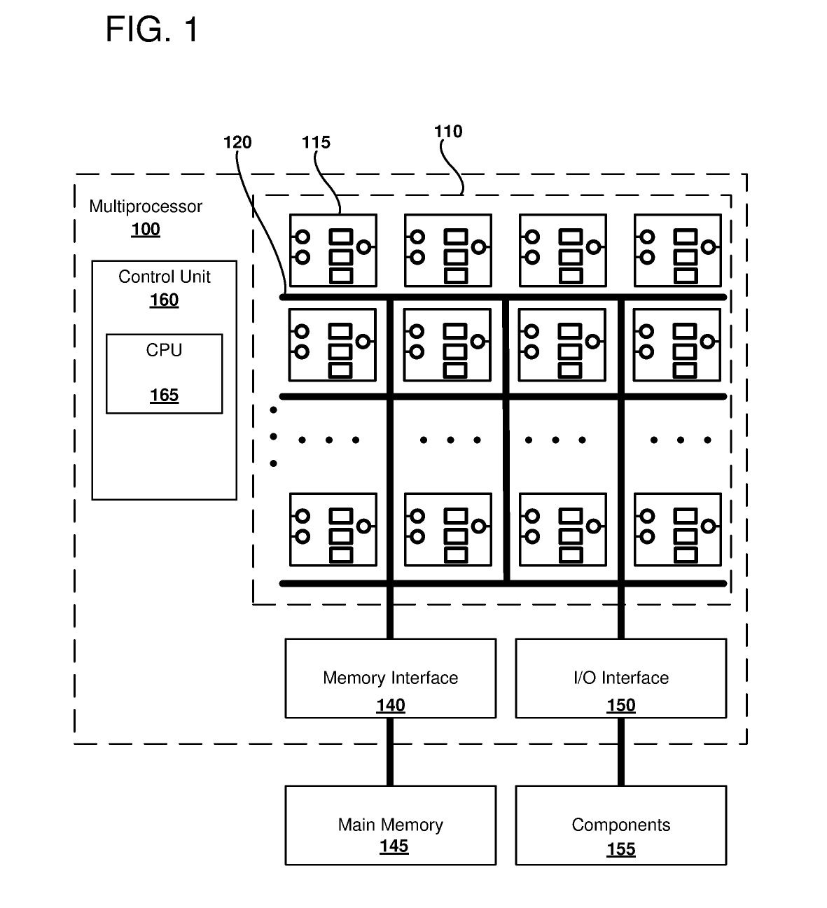

FIG. 1 is a block diagram of a neural network multiprocessor 100, as can be implemented in some examples of the disclosed technology. The multiprocessor 100 includes a plurality 110 of one or more neural processing cores, including individual NN processor core 115. The multiprocessor 100 can be implemented in as a custom or application-specific integrated circuit (e.g., including a system-on-chip (SoC) integrated circuit), as a field programmable gate array (FPGA) or other reconfigurable logic, or as a soft processor virtual machine hosted by a physical, general-purpose processor. For example, a general-purpose processor supporting vector instructions, such as x86 64-bit processors supporting SSE, SSE2, or AVX instructions sets, can be used to implement BFP units.

An individual NN processor core 115 can be programmed to execute a subgraph or an individual node of a neural network. For example, the individual NN processor core 115 can access a local memory used for storing weights, biases, input values, output values, and so forth. The individual NN processor core 115 can have many inputs, where each input can be weighted by a different weight value. For example, the individual NN processor core 115 can produce a dot product of an input tensor and the programmed input weights for the individual NN processor core 115. In some examples, the dot product can be adjusted by a bias value before it is used as an input to an activation function. The output of the individual NN processor core 115 can be stored in the local memory, where the output value can be accessed and sent to a different NN processor core and/or to the control unit 160, for example.

As shown in FIG. 1, the plurality 110 of neural processor cores are connected to each other via interconnect 120. The interconnect 120 carries data and control signals between individual ones of the cores, a memory interface 140, and an input/output (I/O) interface 150. The interconnect 120 can transmit and receive signals using electrical, optical, magnetic, or other suitable communication technology and can provide communication connections arranged according to a number of different topologies, depending on a particular desired configuration. For example, the interconnect 120 can have a crossbar, a bus, a point-to-point bus, or other suitable topology. In some examples, any one of the plurality 110 of cores can be connected to any of the other cores, while in other examples, some cores are only connected to a subset of the other cores. For example, each core may only be connected to a nearest 4, 8, or 10 neighboring cores. The interconnect 120 can be used to transmit input/output data to and from the cores, as well as transmit control signals and other information signals to and from the cores. For example, each of the cores can receive and transmit semaphores that indicate the execution status of operations currently being performed by each of the respective cores. Further, matrix and vector values can be shared between cores via the interconnect. In some examples, the interconnect 120 is implemented as wires connecting the cores and memory system, while in other examples, the core interconnect can include circuitry for multiplexing data signals on the interconnect wire(s), switch and/or routing components, including active signal drivers and repeaters, or other suitable circuitry. In some examples of the disclosed technology, signals transmitted within and to/from the multiprocessor 100 are not limited to full swing electrical digital signals, but the processor can be configured to include differential signals, pulsed signals, or other suitable signals for transmitting data and control signals.

In the example of FIG. 1, the memory interface 140 of the multiprocessor includes interface logic that is used to connect to memory 145, for example, memory located on another integrated circuit besides the multiprocessor 100 (e.g., the memory can be static RAM (SRAM) or dynamic RAM (DRAM)), or memory embedded on the same integrated circuit as the processor (e.g., embedded SRAM or DRAM (eDRAM)). The memory interface 140 and/or the main memory can include caches (e.g., n-way or associative caches) to improve memory access performance In some examples the cache is implemented using static RAM (SRAM) and the main memory 145 is implemented using dynamic RAM (DRAM). In some examples the memory interface 140 is included on the same integrated circuit as the other components of the multiprocessor 100. In some examples, the memory interface 140 includes a direct memory access (DMA) controller allowing transfer of blocks of data in memory. In some examples, the memory interface 140 manages allocation of virtual memory, expanding the available main memory 145. In some examples, programming information (e.g., a configuration bitstream) can be stored in the memory 145 and then applied to configure reconfigurable logic resources of the plurality 110 of neural processing cores.

The I/O interface 150 includes circuitry for receiving and sending input and output signals to other components 155, such as hardware interrupts, system control signals, peripheral interfaces, co-processor control and/or data signals (e.g., signals for a graphics processing unit, floating-point coprocessor, physics processing unit, digital signal processor, or other co-processing components), clock signals, semaphores, or other suitable I/O signals. The I/O signals may be synchronous or asynchronous. In some examples, all or a portion of the I/O interface is implemented using memory-mapped I/O techniques in conjunction with the memory interface 140. In some examples, the I/O signal implementation is not limited to full swing electrical digital signals, but the I/O interface 150 can be configured to provide differential signals, pulsed signals, or other suitable signals for transmitting data and control signals.

The multiprocessor 100 can also include a control unit 160. The control unit 160 supervises operation of the multiprocessor 100. Operations that can be performed by the control unit 160 can include allocation and de-allocation of neural processing cores for performing operations, including matrix and vector multiplication, control of input data and output data between any of the cores, the memory interface 140, and/or the I/O interface 150, modification of execution flow and other changes in control flow. The control unit 160 can including a general-purpose central processing unit (CPU) 165 (e.g., an ARM, MIPS, or x86-64 processor) to implement some or all of the control functions of the control unit 160. For example, instructions stored in memory can be executed by the CPU 165 to allocate, de-allocate, and send data to one or more of the plurality 110 of neural processing cores. In some examples, the CPU 165 is a soft core (e.g., a NIOS or MicroBlaze core), implemented with programmable resources of an FPGA or other reconfigure logic. The soft core can execute an instruction set architecture that is augmented with instructions that are targeted to neural network operations, such as instructions to perform matrix operations and dot product operations.

The control unit 160 can be used to execute a tool flow for compiling, training, installing, and executing a deep neural network graph. As one example, different portions of the tool flow can use different components of the multiprocessor 100. The compilation and training steps can be performed by the CPU 165. After the neural network is trained, the neural network can be used in an inference mode where new data is presented to the neural network for classification. The neural network can be divided into different subgraphs, where a portion of the subgraphs are executed by the CPU 165 and a portion of the subgraphs are executed by the plurality 110 of neural processing cores. The control unit 160 can schedule the data transfer between the CPU 165 and the plurality 110 of neural processing cores so that a latency between the CPU 165 and the plurality 110 of neural processing cores is optimized for the particular division of the subgraphs on the different hardware components.

In some examples, the control unit 160 is implemented at least in part using one or more of: hardwired finite state machines, programmable microcode, programmable gate arrays, or other suitable control circuits.

IV. Example Neural Network Implementation

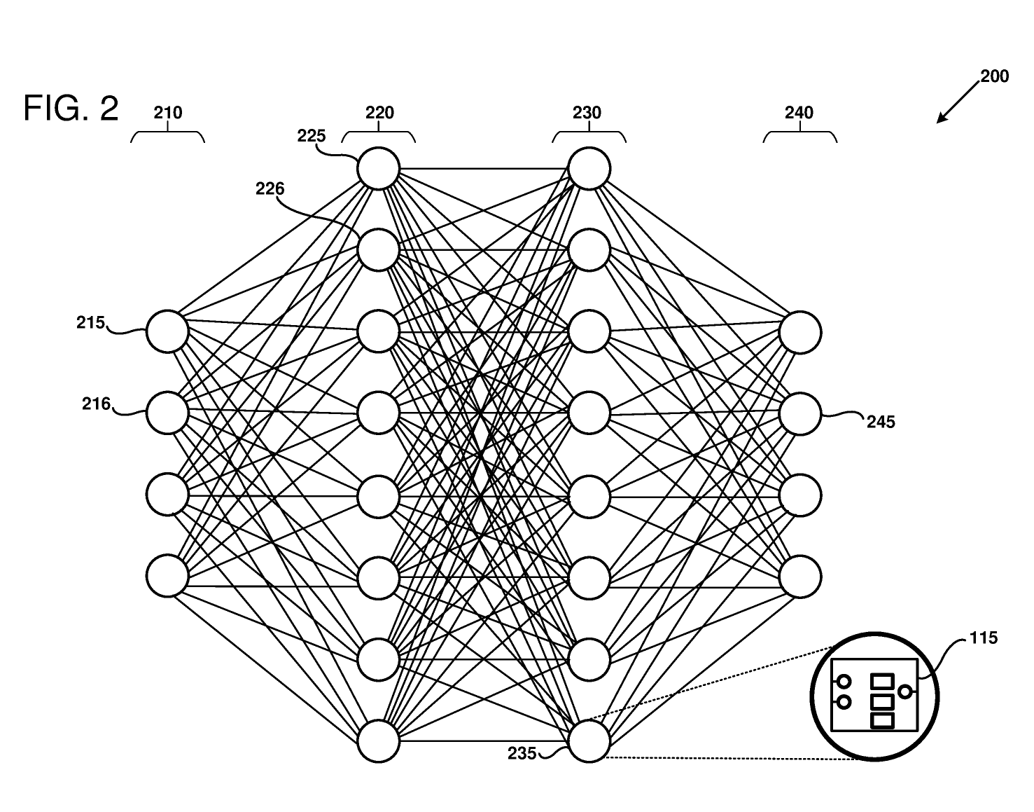

For example, FIG. 2 illustrates a simplified topology of deep neural network (DNN) 200 that can be used to perform enhanced image processing using disclosed BFP implementations. One or more processing layers can be implemented using disclosed techniques for BFP matrix/vector operations, including the use of one or more of the plurality 210 of neural network cores in the multiprocessor 100 described above. It should be noted that applications of the neural network implementations disclosed herein are not limited to DNNs but can also be used with other types of neural networks, such as convolutional neural networks (CNNs), including implementations having Long Short Term Memory (LSTMs) or gated recurrent units (GRUs), or other suitable artificial neural networks that can be adapted to use BFP methods and apparatus disclosed herein.

As shown in FIG. 2, a first set 210 of nodes (including nodes 215 and 216) form an input layer. Each node of the set 210 is connected to each node in a first hidden layer formed from a second set 220 of nodes (including nodes 225 and 226). A second hidden layer is formed from a third set 230 of nodes, including node 235. An output layer is formed from a fourth set 240 of nodes (including node 245). In example 200, the nodes of a given layer are fully interconnected to the nodes of its neighboring layer(s). In other words, a layer can include nodes that have common inputs with the other nodes of the layer and/or provide outputs to common destinations of the other nodes of the layer. In other examples, a layer can include nodes that have a subset of common inputs with the other nodes of the layer and/or provide outputs to a subset of common destinations of the other nodes of the layer.

Each of the nodes produces an output by applying a weight to each input generated from the preceding node and collecting the weights to produce an output value. In some examples, each individual node can have an activation function and/or a bias applied. Each of the nodes can be implemented using an instance of the neural network core 115, for example, as shown for the hidden node 235. For example, any appropriately programmed processor or FPGA can be configured to implement the nodes in the depicted neural network 200.

Examples of suitable applications for such neural network BFP implementations include, but are not limited to: performing image recognition, performing speech recognition, classifying images, translating speech to text and/or to other languages, facial or other biometric recognition, natural language processing, automated language translation, query processing in search engines, automatic content selection, analyzing email and other electronic documents, relationship management, biomedical informatics, identifying candidate biomolecules, providing recommendations, or other classification and artificial intelligence tasks.

In some examples, a set of parallel multiply-accumulate (MAC) units in each convolutional layer can be used to speed up the computation. Also, parallel multiplier units can be used in the fully-connected and dense-matrix multiplication stages. A parallel set of classifiers can also be used. Such parallelization methods have the potential to speed up the computation even further at the cost of added control complexity.

As will be readily understood to one of ordinary skill in the art having the benefit of the present disclosure, the application of neural network implementations can be used for different aspects of using neural networks, whether alone or in combination or subcombination with one another. For example, disclosed implementations can be used to implement neural network training via gradient descent and/or back propagation operations for a neural network. Further, disclosed implementations can be used for evaluation of neural networks.

V. Example Neural Network Model and Subgraph

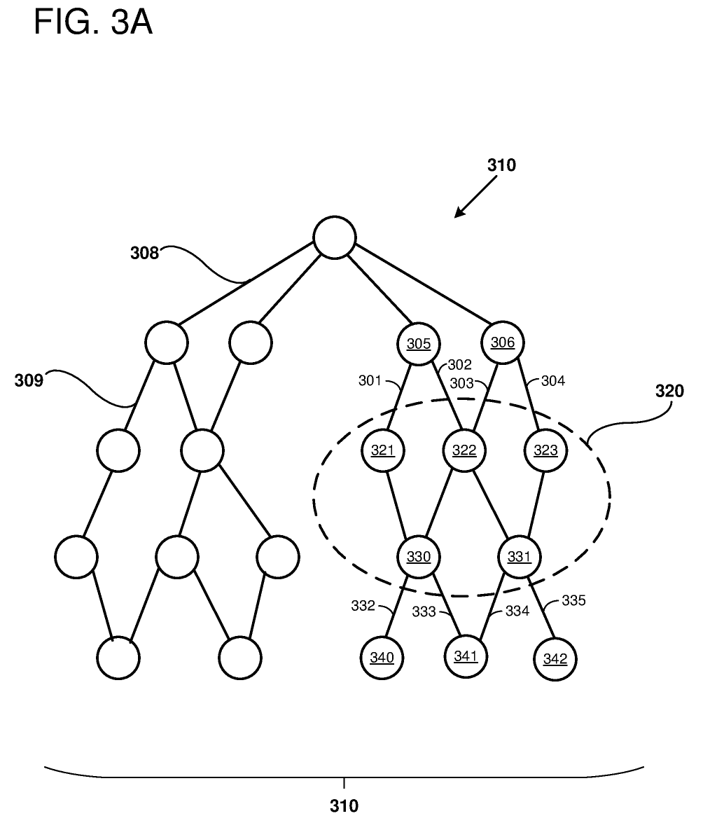

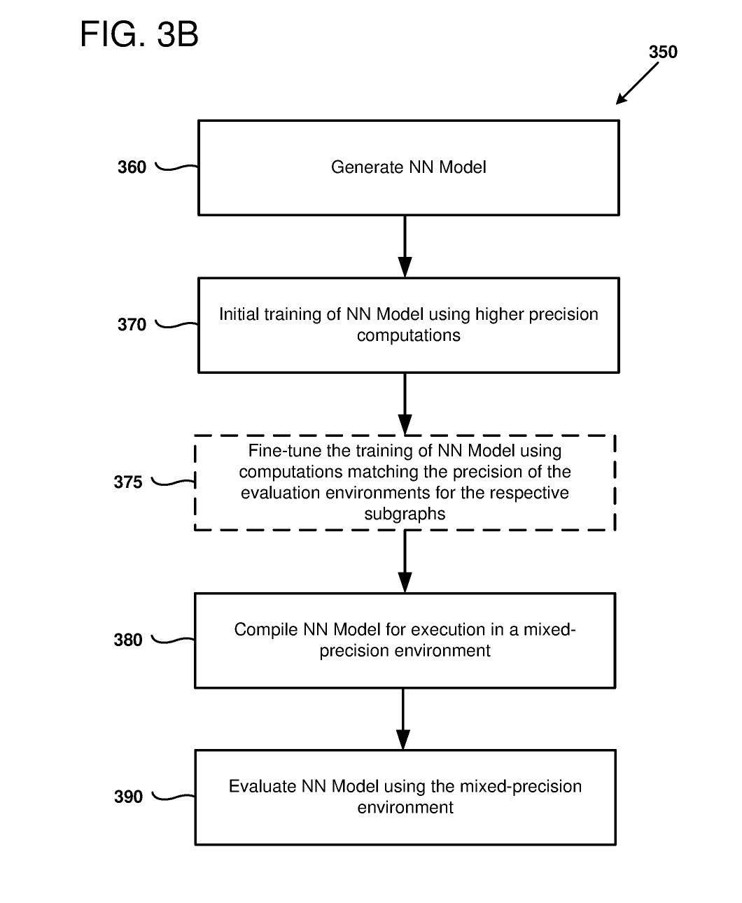

FIG. 3A is a diagram illustrating an a high level of abstraction of a neural network model 310, as can be used in certain examples of the disclosed technology. As shown in FIG. 3A, a number of neural nodes are provided. The neural nodes (e.g., neural nodes 305 and 306) are connected to each other by one or more edges (e.g., edges 308 and 309). Each of the neural nodes has one or more weights and a bias associated with it. Generally, a neural node calculates a dot product of the neural node's input and its weights, where the input and/or the weights can be a tensor, a vector, or a scalar value. The dot product can be added to an optional bias value that can be positive or negative. The sum of the dot product can be used as an input to an optional activation function. However, any suitable type of node can be used. In some examples, the neural node is a combinational node, in other words the node is stateless and the node's output is a function of the node's inputs, weights, and biases. In some examples, the neural node is a recurrent node. In such cases, at least some of the node's inputs are back-propagated from downstream nodes in the neural network. In some examples, the neural node includes state. Such nodes will have an output that is a function not only of the node's input, weights, and biases, but which will also include one or more state values associated with the node. Such state nodes typically have logic defining how the node's state is updated.

Neural network models such as the neural network model 310 shown in FIG. 3A may include a number of input nodes, output nodes, and internal or deep nodes. The neural network model 310 can be evaluated using a general-purpose processor. Typically, the network is modeled as a matrix of values that describe the node weights, biases, and edge connections. Node values may be “trained” by applying a set of training stimulus to the input of the neural network and comparing the output to a desired goal. Node weights and biases are adjusted in order to converge the output of the neural network to the desired goal.

As shown in FIG. 3A, a subgraph 320 of the neural network model 310 is identified by a dashed circle. As illustrated, the subgraph 320 includes neural nodes 321-323 and 330-331. Inputs to the subgraph 320 are generated by the neural nodes 305-306. The neural nodes 321-323 form a first layer of the subgraph 320 that receives the input values of the subgraph. The output generated by the neural node 305 is transmitted by the edges 301 and 302 to the neural nodes 321 and 322, respectively. The output generated by the neural node 306 is transmitted by the edges 303 and 304 to the neural nodes 322 and 323, respectively. The edges 301-304 connecting the nodes 305-306 to the nodes 321-323 are at an input boundary of the subgraph 320.

Outputs of the subgraph 320 are generated by the neural nodes 330-331. The neural nodes 330-331 form a second layer of the subgraph 320 that generates the output of the subgraph 320. Specifically, the output generated by the neural node 330 is transmitted by the edges 332 and 333 to the neural nodes 340 and 341, respectively. The output generated by the neural node 331 is transmitted by the edges 334 and 335 to the neural nodes 341 and 342, respectively. The edges 332-335 connecting the nodes 330-331 to the nodes 340-342 are at an output boundary of the subgraph 320.

The subgraph 320 can be identified in a number of different ways. For example, a compiler can identify the subgraph. As another example, a user can identify a subgraph using a graphical tool, by using one or more predefined application programming interfaces (APIs) to specify the neural network, and/or by providing markers (e.g., marker nodes) in a coding language for the neural network to indicate boundaries of the subgraph.

Once the subgraph 320 has been identified, the neural network model 310 can be partitioned such that the subgraph 320 is evaluated with a neural network hardware accelerator. For example, the subgraph 320 can be mapped to specialized neural network hardware implemented with an FPGA, an ASIC, a neural network processor, a digital signal processor, a graphics processing unit (GPU), or other suitable acceleration hardware.

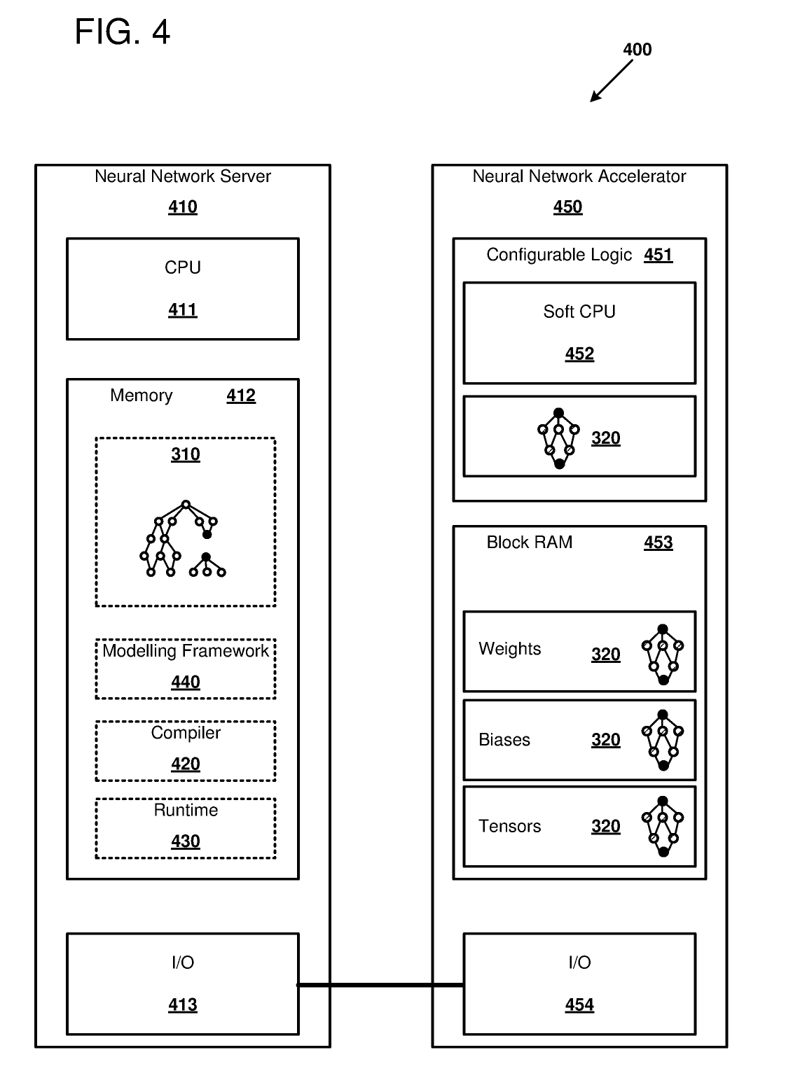

FIG. 3B is a flow chart 350 outlining an example method of using a neural network model, such as the neural network model 310. Specifically, the example method can be used to develop, train, and evaluate a neural network model on a system including a neural network accelerator. For example, the illustrated method can be implemented using the neural network server 410 and neural network accelerator 450 discussed below regarding FIG. 4. One or more of the process blocks can be performed by tools of a tool flow, such as the tools 420, 430, and 440 discussed below regarding FIG. 4.

At process block 360, a neural network model is generated. As one example, a data scientist can specify an architecture for the neural network model using a programming language or other tool. The architecture for the neural network model can include a number of layers of the neural network, a number of nodes (e.g., neurons) within a layer, activation functions for the neural nodes, training weights, and so forth. The data scientist can specify the neural network model using one or more predefined APIs in a source code file to specify the neural network. A subgraph (such as subgraph 320) can be identified within the source code for acceleration, such as by using a predefined API that supports acceleration.

At process block 370, the neural network model can be initially trained using higher precision computations, where the higher precision can be relative to the lower precision of a neural network accelerator. A neural network model is trained by applying a set of input data to the neural network model and refining weights of the model until the weights converge to a value that produces a desired output from the neural network model. Different models can converge at different rates or may not converge at all. During the initial training, using higher precision computations may help the model to converge and/or converge faster as compared to using lower precision computations. A general-purpose CPU may include higher precision functional units than a neural network accelerator. Thus, performing the initial training on a general-purpose CPU using higher precision computations can decrease the time for training a neural network model, even when subgraphs of the neural network model could be accelerated on the neural network accelerator using lower precision computations.

At process block 375, the training of the neural network model can optionally be refined. For example, the training of the neural network model can be fine-tuned using computations that match the precision of the valuation environments for respective subgraphs of the neural network model. Specifically, subgraphs of the neural network model that will be executed in higher precision environments (such as a general-purpose CPU) can be trained using higher precision computations. Subgraphs of the neural network model that will be executed in lower precision environments (such as a neural network accelerator) can be trained using lower precision computations. Thus, the fine-tuning of the training can occur by applying mixed-precision computations to the neural network model during later phases of the training. By fine-tuning the training, the results during evaluation may be more accurate as compared to training only with a precision that is mismatched to the precisions used during evaluation.

At process block 380, the neural network model can be compiled for execution and a mixed-precision environment. For example, portions of the neural network model that are to be executed on a CPU or GPU can be partitioned from portions of the neural network model that are to be executed on a neural network accelerator. The compiler can generate interfaces between the portions of the neural network model that are executed in the different environments. The compiler can generate a configuration bitstream and/or code for programing the neural network accelerator.

At process block 390, the neural network model can be evaluated using a mixed-precision environment. As one example, the mixed-precision environment can include a general-purpose CPU and a neural network accelerator. As another example, the mixed-precision environment can include a general-purpose CPU and a GPU. As another example, the mixed-precision environment can include only a general-purpose CPU. In particular, the general-purpose CPU can be used to simulate a mixed-precision environment prior to deploying the neural network model to a special-purpose hardware solution having a mixed-precision environment. Thus, the characteristics of a mixed-precision environment can be evaluated using a general-purpose system before the neural network model is deployed to a special-purpose mixed-precision environment. This ability may result in a reduced time-to-market and/or reduced development costs.

VI. Example Neural Network Server and Neural Network Accelerator

FIG. 4 is a diagram illustrating an example system 400 including a neural network server 410 coupled to a neural network accelerator 450, as can be implemented in certain examples of the disclosed technology. The illustrated system 400 can be used to perform any of the methods disclosed herein.

As shown in FIG. 4, the neural network server 410 includes a processor 411 (CPU), memory 412, and an input/output interface 413 (I/O). The neural network server 410 can be used to specify, train, and evaluate a neural network model using a tool flow that includes a hardware-agnostic modelling framework 440 (also referred to as a native framework or a machine learning execution engine), a compiler 420, and a runtime environment 430. The memory includes computer-executable instructions for the tool flow including the native framework 440, the neural network compiler 420, and the neural network runtime environment 430. The tool flow can be used to generate neural network data 310 representing all or a portion of the neural network model, such as the neural network model discussed above regarding FIG. 3A. It should be noted that while the tool flow is described as having three separate tools (420, 430, and 440), the tool flow can have fewer or more tools. For example, the functions of the different tools (420, 430, and 440) can be combined into a single modelling and execution environment.

The neural network data 310 can be stored in the memory 412. The neural network data 310 can be represented in one or more formats. For example, the neural network data 310 corresponding to a given neural network model can have a different format associated with each respective tool of the tool flow. Generally, the neural network data 310 can include a description of nodes, edges, groupings, weights, biases, activation functions, and/or tensor values. As a specific example, the neural network data 310 can include source code, executable code, metadata, configuration data, data structures and/or files for representing the neural network model.

The native framework 440 can be used to define and use a neural network model. As one example, the native framework 440 can include pre-defined APIs and/or programming primitives that can be used to specify one or more aspects of the neural network model. The pre-defined APIs can include both lower-level APIs (e.g., activation functions, cost or error functions, nodes, edges, and tensors) and higher-level APIs (e.g., layers, convolutional neural networks, recurrent neural networks, linear classifiers, and so forth). “Source code” can be used as an input to the native framework 440 to define a topology of the graph of a given neural network model. In particular, APIs of the native framework 440 can be instantiated and interconnected within the source code to specify a complex neural network model. A data scientist can create different neural network models by using different APIs, different numbers of APIs, and interconnecting the APIs in different ways.

In addition to the source code, the memory 412 can include training data. The training data includes a set of input data for applying to the neural network model and a desired output from the neural network model for each respective dataset of the input data. The native framework 440 can be used to train the neural network model with the training data. An output of the training is the weights and biases that are associated with each node of the neural network model. After the neural network model is trained, the native framework 440 can be used to classify new data that is applied to the trained neural network model. Specifically, the trained neural network model uses the weights and biases obtained from training to perform classification and recognition tasks on data that has not been used to train the neural network model. The native framework 440 generally uses only the CPU 411 to execute the neural network model and so it may not achieve real-time performance for some classification tasks. The native framework 440 may also support using a GPU (not shown) or other accelerator to execute the neural network model, but the performance may still not reach real-time performance. Examples of native frameworks include Caffe (available from UC Berkeley), Tensorflow (available from Google), and Cognitive Toolkit (CNTK—available from Microsoft Corporation).

The compiler 420 analyzes the source code and data (e.g., the weights and biases learned from training the model) provided for a neural network model and transforms the model into a format that can be accelerated on the neural network server 410 and/or the neural network accelerator 450. Specifically, the compiler 420 transforms the source code into executable code, metadata, configuration data, and/or data structures for representing the neural network model and memory as neural network data 310 and the neural network subgraph data 320. The compiler 420 can divide the neural network model into portions (e.g., neural network 310) that can be executed on the neural network server 410 (such as by using the CPU 411 and/or a GPU (not shown)) and other portions (e.g., neural network subgraph 320) that can be executed on the neural network accelerator 450. Specifically, the compiler 420 can identify subgraphs of the neural network model and determine which of those subgraphs will be executed on the server 410 and which of those subgraphs will be executed on the accelerator 450. The compiler 420 can generate executable code (e.g., runtime modules) for executing the subgraphs assigned to the server 410 and for communicating with the subgraphs assigned to the accelerator 450.

The compiler 420 can generate configuration data for the accelerator 450 that is used to configure accelerator resources to evaluate the subgraphs assigned to the accelerator 450. The accelerator resources can include hardware, software, and/or a combination of hardware and software. For example, the resources can be implemented on a programmable logic platform, such as an FPGA. The resources can include configurable logic blocks (such as programmable combinatorial and sequential logic), memory elements (such as block RAMs and register files), application-specific logic (such as hard macros for input/output and processing), and executable code for execution on a hard or soft CPU. The compiler 420 can create data structures for storing values generated by the neural network model during execution and/or training and for communication between the server 410 and the accelerator 450. The compiler 420 can generate metadata and code that can be used to identify subgraphs, edge groupings, training data, and various other information about the neural network model during runtime. For example, the metadata can include information for interfacing between the different subgraphs of the neural network model. In particular, marker nodes can be inserted at the interface of different subgraphs. The marker nodes can be added by the compiler during compilation. Alternatively, the marker nodes can be added prior to compilation so that the marker nodes can be used to identify an area of the neural network model to be accelerated.

The compiler 420 can identify input edges of each subgraph and output edges of each subgraph. The input and output edges can be grouped according to the connectivity of the edges. For example, all of the input edges connected to a first layer of the subgraph can be in one group and all of the input edges connected to a different layer of the subgraph can be in another group. Similarly, all of the output edges connected to a given layer of the subgraph can be grouped together. In a simple case, all of the input edges are connected to a single layer of the subgraph and belong to a first group, and all of the output edges are connected to a different layer of the subgraph and belong to a second group. The compiler 420 can assign a different identifier for each respective group of edges. The identifier can be used by the runtime when communicating input and output values between the neural network server 410 and the neural network accelerator 450. The identifier can also be used by the compiler 420 as a key to keep memories and/or nodes associated with a group of edges in close physical proximity on the neural network accelerator 450.

The runtime environment 430 provides an executable environment or an interpreter that can be used to train the neural network model during a training mode and that can be used to evaluate the neural network model in an inference or classification mode. During the inference mode, input data can be applied to the neural network model inputs and the input data can be classified in accordance with the training of the neural network model. The input data can be archived data or real-time data. As a specific example, the input data can be pixel data from a video feed capturing video of an assembly line producing a particular product. During the training mode, the neural network can be trained to differentiate between properly manufactured products and defective products. After training and during the inference mode, live or delayed video data can be used as an input to the neural network model and the neural network model can determine whether products on the assembly line are defective or not defective.

The runtime environment 430 can include a deployment tool that, during a deployment mode, can be used to deploy or install the subgraphs to be accelerated on the neural network accelerator 450. Specifically, the deployment tool can cause a configuration bitstream to be loaded on configurable logic of the neural network accelerator 450 so that the accelerated subgraph is configured for operation on the neural network accelerator 450. Additionally, the deployment tool can cause the training data to be loaded on memories of the neural network accelerator 450. Thus, the deployment of the subgraph architecture and training data can occur before the neural network model is evaluated in the inference mode. By separating the communication of subgraph structure and training data from the communication of input and output data of the subgraph, the communication between the server 410 and the accelerator 450 can be more efficient during evaluation of the neural network model.

The runtime environment 430 can include a scheduler that manages the execution of the different runtime modules and the communication between the runtime modules and the neural network accelerator 450. Thus, the runtime environment 430 can be used to control the flow of data between nodes modeled on the neural network server 410 and the accelerated subgraphs provided at the neural network accelerator 450.

The neural network accelerator 450 is used to accelerate evaluation and/or training of neural network subgraphs, typically with increased speed and reduced latency that is not realized when evaluating the subgraph only on the neural network server 410. In the illustrated example, the accelerator is an FPGA-based accelerator, however any suitable hardware accelerator can be used that models neural networks. As shown, the accelerator 450 includes configuration logic 451 which provides a soft CPU 452. The soft CPU 452 supervises operation of the accelerated subgraph on the accelerator 450 and can manage communications with the server 410. The soft CPU 452 can also be used to configure logic and to control loading and storing of data from RAM on the accelerator, for example block RAM 453.

The block RAM 453 shown stores values for the neural network subgraph 320 weights, biases, and tensors. Additional functionality for performing operations on the subgraph may be programmed in the configurable logic 451, as shown. For example, interconnections and logic that provide operation for the subgraph can be programmed into the configurable logic 451 and interface with both the block RAM 453 storing the node values as well as the accelerator 450 interface I/0 454.

The compiler 420 and the runtime 430 provide a fast interface between the server 410 and the accelerator 450. In effect, the user of the neural network model may be unaware that a portion of the model is being accelerated on the provided accelerator. For example, node values are typically propagated in a model by writing tensor values to a data structure including an identifier. The runtime 430 associates subgraph identifiers with the accelerator, and provides logic for translating the message to the accelerator, transparently writing values for weights, biases, and/or tensors to the block RAM 453 of the accelerator, without program intervention. Similarly, values that are output by the subgraph 320 may be transparently sent back to the server 410 with a message including an identifier of a receiving node at the server and a payload that includes values such as weights, biases, and/or tensors that are sent back to the overall neural network model.

The interface between the server 410 and the accelerator 450 can include conversion of values between a generic model implemented on the server and a specific instance of a model implemented for the subgraph on the accelerator. For example, many software-implemented neural network models may model node and other network value using 32-bit values. The neural network accelerator 450 may model subgraphs using a fewer number of bits, for example 16, 8, 5, 4, or other number of bits. The provided interface can implement this quantization by converting values to and from the appropriate formats when passing between the server and the accelerator. Other examples of functions that can be provided by the interface include specifying filters, size of embedded input, convolution specifications, activation functions, and sigmoid functions. Attributes of the subgraph can also be selected, for example, data types for initial states and expected outputs, a number of iterations to run in parallel on the subgraph, swapping of memory, for example for back propagation from the accelerator to the server, shaped format of input and output tensors, scope names, or other suitable attributes.

VII. Example Model Partitioning with Markers

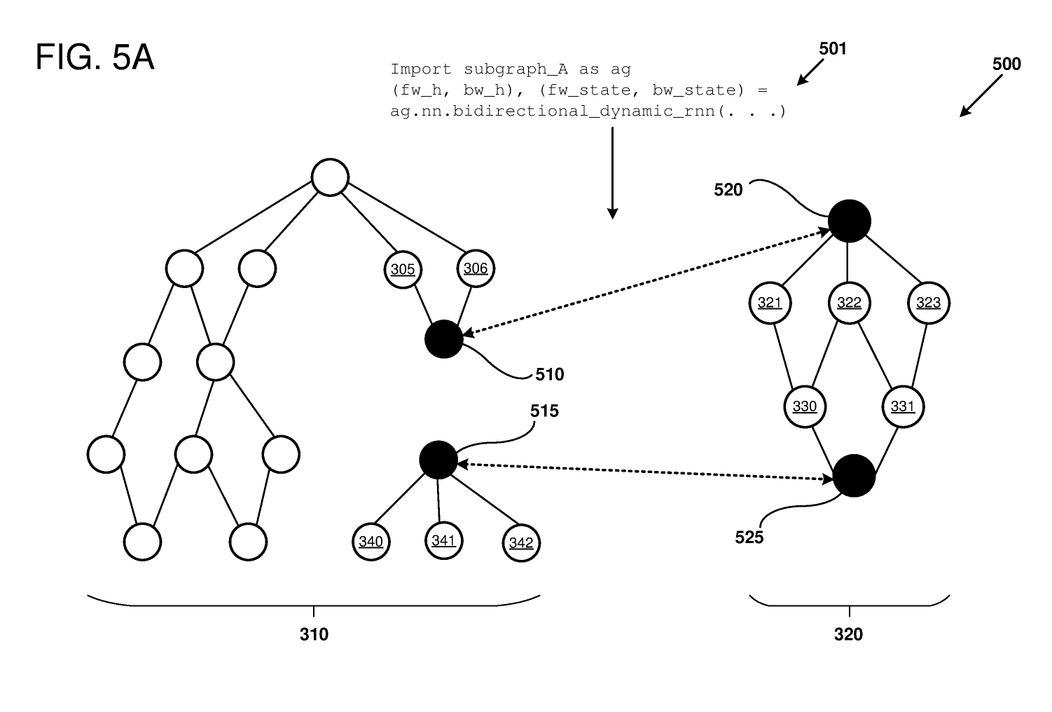

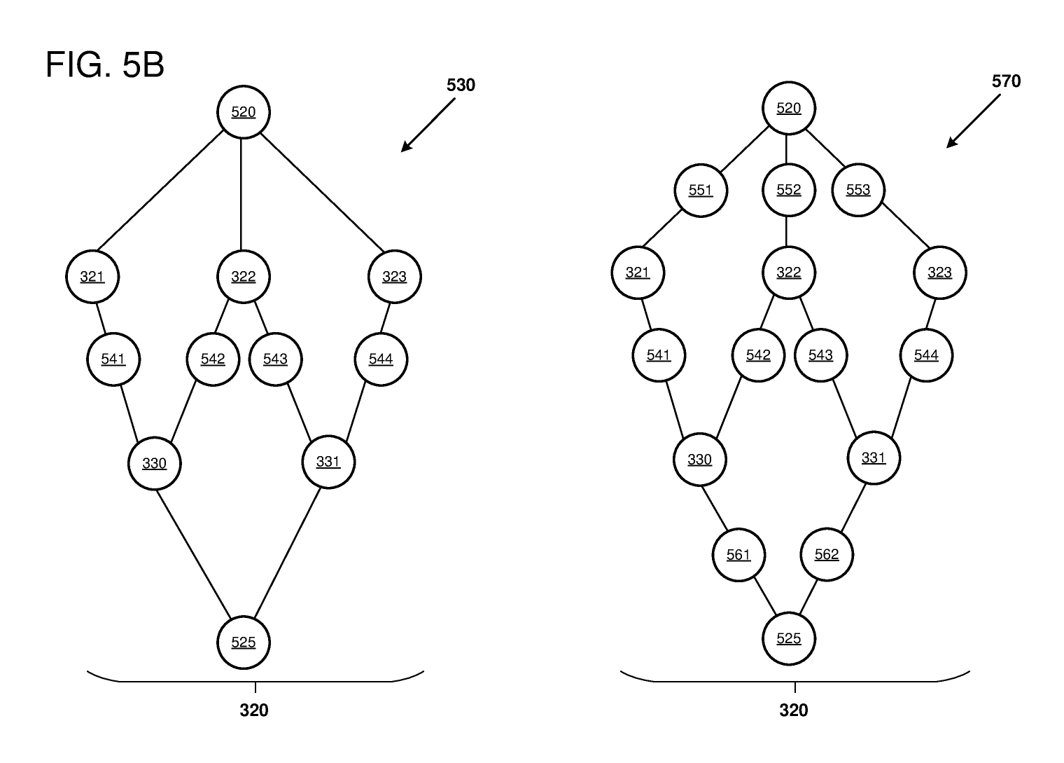

FIG. 5A is a diagram 500 depicting a graphical representation of an example of a neural network model 310 and a subgraph 320. At different points in a lifecycle of the neural network model, the different portions of the neural network model can be executed on different hardware platforms. For example, during initial training, both the neural network model 310 and the subgraph 320 can be executed on a general-purpose CPU that performs computations with relatively high precision (e.g., using the single or double formats of IEEE 754-1985 with 24 or 53 bits for the significand, respectively). During a fine-tuning of the training and during inferencing of the neural network model 310 and the subgraph 320, the subgraph 320 can be accelerated on a neural network accelerator using lower precision computations (e.g., using a format with eight or fewer bits for the significand). Additionally, an effect of executing the subgraph 320 on the neural network accelerator can be simulated by executing both the neural network model 310 and the subgraph 320 on a general-purpose CPU during an inference mode. In particular, when the subgraph 320 is executed on a general-purpose CPU, the computations of the subgraph 320 can be truncated or rounded to match a precision of the accelerator.

FIG. 5A further includes an example of an API interface 501 that can be used to specify the partition between the model 310 and its subgraph 320. Additionally or alternatively, a partitioning of the subgraph 320 from the neural network model 310 can be accomplished by inserting marker nodes between the subgraph 320 and the neural network model 310. A marker node includes information that identifies the marker node as a boundary of a subgraph. The marker node includes an input connected to an edge that is connected to a neural node external to the subgraph. The marker node includes an output connected to an edge that is connected to a neural node internal to the subgraph. The marker node is not a neural node because it does not perform neural node operations.

The marker nodes can be used in the implementing code of the API. As shown, the neural network model 310 includes a number of inserted marker nodes 510 and 515. Further shown, there are also corresponding marker nodes 520 and 530 that have been inserted into the subgraph 320. In some examples, only one of the neural network model 310 or its subgraph 320 includes the marker nodes. In other examples, interface functionality is split between marker nodes located at both the model 310 and its subgraph 320.

The marker nodes can provide a seamless interface between the neural network model 310 and the subgraph 320. The marker nodes can include metadata for use by various tools of the tool flow, and/or additional functionality such as translation and/or interface logic. The marker nodes can be defined using the language primitives of the native framework. For example, marker nodes can be identified using a particular naming convention (e.g., a name of the node can include the term “marker_node”) for the node and/or by using pragmas embedded in source code comments of the native framework. Logic of the marker nodes can be implemented using the language primitives of the native framework. Metadata of the marker nodes can be implemented by embedded in comments of the native framework.

The marker nodes can perform different functions during different phases of operation of the neural network model. For example, during initial training, when both the neural network model 310 and the subgraph 320 are executed on a general-purpose CPU, the marker nodes can merely pass values from the respective nodes of the neural network model 310 and the respective nodes of the subgraph 320 as if the marker nodes were not present. In other words, the marker nodes can perform a pass-through or no-operation function during initial training. When finalizing training, the marker nodes can perform a translation of values going to and being received from the subgraph. As one example, when there is a change in precision or quantization between the neural network model and its subgraph, this change can be accommodated using logic implemented at the marker nodes. Specifically, the marker nodes can be used to truncate or round values destined for and/or leaving from the subgraph 320. In this manner, a precision of the values entering and/or leaving the subgraph 320 can be matched to a precision of the neural network accelerator. The marker nodes can also perform the translation when simulating the subgraph executing on the neural network accelerator, but while using the general-purpose CPU.

The marker nodes can include metadata (also referred to as artifacts) used for formatting communications between the model 310 and the subgraph 320. One example of metadata is a subgraph identifier that can be used to identify characteristics of the information that is communicated between the model 310 and its subgraph 320. Another example of metadata is connectivity information for routing input values of the subgraph 320 to respective nodes of the subgraph 320. In particular, a mapping of input values to internal resources of the accelerator can be provided. The metadata can include data structures and/or communication protocols that are used for communicating information between the subgraph 320 and the neural network model 310. Thus, the metadata can include a format for communicating input values (such as via a message or packet) to the subgraph 320 and/or for communicating output values from the subgraph 320. As one example, the values can be transferred between the subgraph 320 and the general-purpose CPU using a tensor data structure. A tensor is a data structure organized as an array of numbers. The tensor array is characterized by a degree or order of the tensor. A zeroth-order tensor is a scalar, a first-order tensor is a vector (i.e., a one-dimensional array), a second-order tensor is a two-dimensional array, and so forth. Each dimension of the tensor can have a different respective number of elements or values. The values of a given tensor can be packed linearly within the packet 530. A length of the tensor can be a product of the number of the elements of each respective dimension. Thus, a two-dimensional tensor with three elements in the first dimension and two elements in the second dimension can have a length of six and be packed in six linear fields of the data structure. In another embodiment, the marker nodes can be used as a key to signal the compiler to generate the logic for communication, grouping payloads, and so forth.

The marker nodes can include metadata used during compilation of the subgraph 320. For example, the compiler can use the marker nodes to identify a boundary of the subgraph 320 to be accelerated, and the compiler can generate configuration code for the subgraph that is bounded within the marker nodes. The marker nodes can include information about an interface between the neural network accelerator and the general-purpose CPU so that the compiler can generate appropriate interface support logic. The metadata can include additional information, such as a type of hardware used to accelerate the subgraph.

FIG. 5B is a diagram depicting additional examples of the subgraph 320 that can be mapped to a hardware accelerator for evaluation of that portion of the neural network. In particular, the implementation 530 of the subgraph 320 can include additional nodes (541-544) interspersed between internal nodes (321-323 and 330-331) of the subgraph 320. The additional nodes can be quantization nodes 541-544 that are used to round or truncate the values passing between the internal nodes of the subgraph. The quantization nodes 541-544 can include conditional logic to operate differently depending upon how the subgraph is currently being used. For example, during initial training a quantization node can provide no-operation or pass-through functionality so that the computations of the internal neural nodes are performed at the higher precision of the general-purpose CPU. During fine-tuning of the training, the quantization nodes 541-544 can perform the rounding and truncation operations to model the effect of the lower precision of the neural network accelerator. The quantization nodes 541-544 can be ignored by the compiler since quantization will automatically occur when the nodes are mapped to the hardware of the neural network accelerator.

The implementation 570 shows another example of how the subgraph 320 can be implemented. In this example, quantization nodes 551-553 and 561-562 can also be placed between the marker nodes 520 and 525 and the internal nodes (321-323 and 330-331) of the subgraph. Thus, the marker nodes 520 and 525 can exclude the functionality that is performed by the quantization nodes.

### VIII. Example Field Programmable Gate Array Architecture

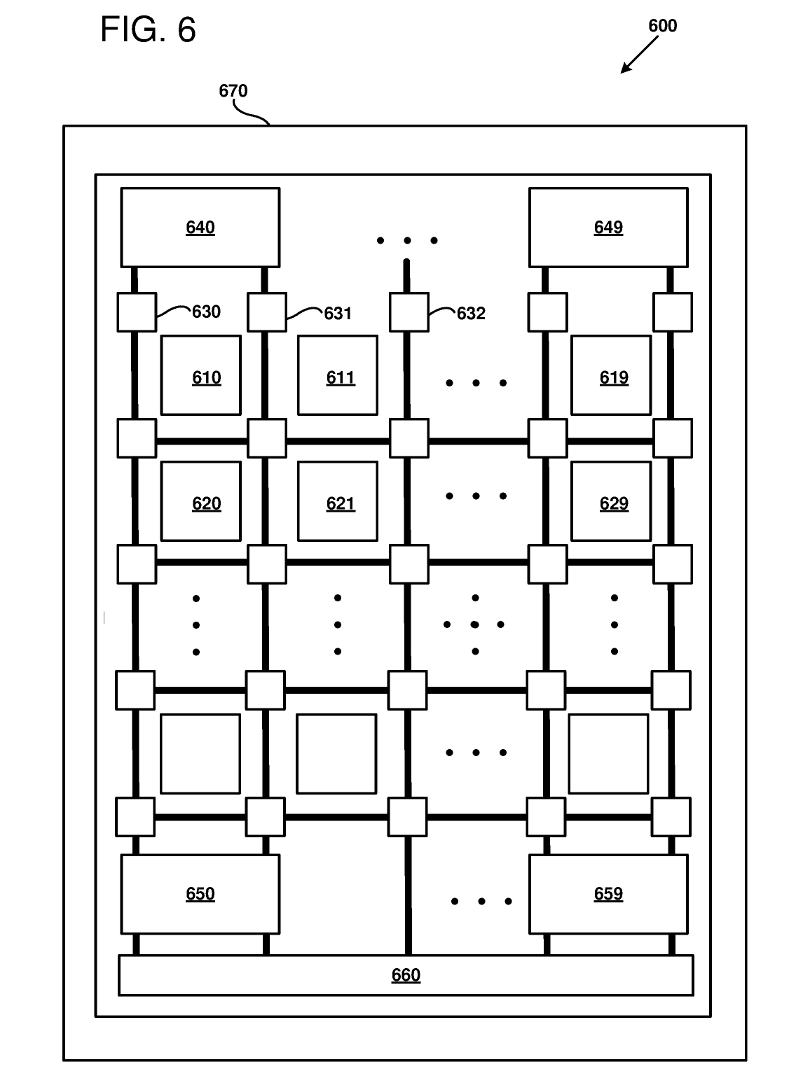

FIG. 6 is a block diagram 600 that depicts an example field programmable gate array (FPGA) architecture that is configured to implement certain examples of the disclosed technology. For example, the multiprocessor 100 discussed above regarding FIG. 1, the configurable logic 451 discussed above regarding FIG. 4, and/or the resources 550 discussed above regarding FIG. 5C, can be mapped to the FPGA architecture of FIG. 6.

The FPGA includes an array of reconfigurable logic blocks arranged in an array. For example, the FPGA includes a first row of logic blocks, including logic blocks 610, 611, and 619, and a second row of logic blocks including logic blocks 620, 621, and 629. Each of the logic blocks includes logic that can be reconfigured to implement arbitrary logic functions and can also include sequential logic elements such as latches, flip-flops, and memories. The logic blocks are interconnected to each other using a routing fabric that includes a number of interconnect switches that can also be programmable. For example, there is a first row of switch blocks 630, 631, 632, etc., positioned between the first row of reconfigurable logic blocks and the second row of reconfigurable logic blocks. The switches can be configured in order to change wire connections that carry signals between the reconfigurable logic blocks.

The FPGA also includes a number of more complex components. For example, the logic block includes a number of block RAMs, for example, block RAM 640 and block RAM 649. The block RAMs typically contain a larger number of memory bits, for example, a few thousand memory bits that are accessed by applying an address to the memory, and reading from one or more read ports. In some examples, the block RAMs can include two or more write ports and two or more read ports. In other examples, the block RAMs may only have a single read and/or a single write port. While the block RAMs are typically accessed by applying an address and reading corresponding data, in some examples, the block RAMs can be configured with additional circuitry that allows for implementation of more complex functions including shift registers and First-In First-Out (FIFO) buffers.

The illustrated FPGA also includes a number of hard macro blocks including hard macro block 650 and hard macro block 659. These macro blocks can include more complex functionality such as processor functionality, digital signal processing functionality, accelerators, or other functions deemed to be desirable. For example, digital signal processing blocks or general-purpose CPU cores can be implemented as one or more hard macro blocks of the FPGA. The illustrated FPGA further includes a configuration port 660 that can be used to reprogram logic devices in the FPGA. In some examples, configuration memories that store configuration information for the logic devices can be addressed and read/written to directly. In other examples, a scan chain architecture is used to store configuration information in a serial manner

The FPGA is further surrounded by an I/0 ring 670 that can be coupled to the logic blocks, the block rams, and/or the hard macro blocks in order to receive and send signals to components away from the FPGA. In some examples, the I/O signals are full rail voltage signals, while in other examples, differential signals are used. In some examples, the I/0 ports can be multiplexed (e.g. time-multiplexed) in order to support input and output of more signals than the number of pins available on the FPGA.

While many examples of FPGAs are typically reconfigurable an arbitrary number of times through the use of electrically erasable memories, in other examples, one-time programmable logic elements can be used. For example, the logic blocks and switches can be programmed with the use of fuses, anti-fuses, or with a ROM mask to program a logic function once that is not easily reversible.

In the reconfigurable case, the FPGA typically has a configuration port that receives data according to a file dubbed a bitstream, or a configuration bitstream. The bitstream data is read into the device and used to program and configure the logic blocks, the switches, the block rams, and/or the hard macros. When a new design is desired, the configuration can be erased and a new design configured into the device. In some examples, the FPGA can be partially reconfigured in order to save on programming time. For example, a subset of the logic blocks, the switches, or block rams can be dynamically reconfigured in the field without reprogramming the entire device.

Using the disclosed technologies, higher performance, and/or more efficient structures can be implemented. Further, it should be readily understood that while some examples of the FPGAs are a stand-alone integrated circuit, in other examples, the FPGA may be packaged differently, for example, in a multi-chip module (MCM), or on the same circuit die as a custom or basic system-on-chip (SoC).

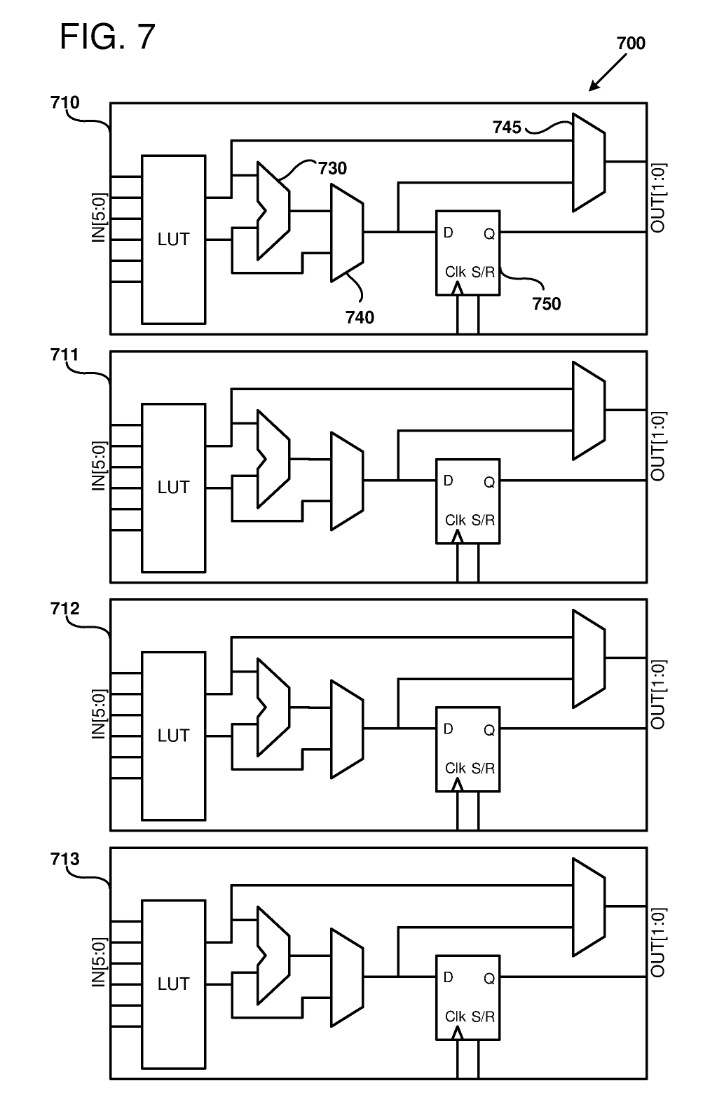

FIG. 7 is a block diagram 700 illustrating four reconfigurable logic blocks 710, 711, 712, and 713 that can configured to form part of the logic fabric of an example FPGA-integrated circuit. For ease of explanation, the components inside the reconfigurable logic blocks shown are identical, or homogenous, but it should be readily understood, in other examples, more than one type of reconfigurable logic block may be present on a single FPGA.

A first reconfigurable logic block 710 includes a six-input Look Up Table (LUT) 720 that is coupled to carry logic 730, a number of multiplexers 740 and 745, and a storage element (here, a D flip-flop) 750. The LUT 720 can be implemented using a small memory (for example, a memory having six address bits and two output bits as shown). Thus, any six-input Boolean function can be implemented by using a single LUT. In some examples, outputs of LUTs can be combined, or a reconfigurable logic block can have multiple LUTs that can be connected together in order to perform more complex logic functions. In some examples, common logic functions can be providing in addition to the LUT. For example, the carry logic 730 can be configured to perform the carry propagation logic for an adder. The multiplexers are used to select various output from other components. For example, the multiplexer 740 can be used to select the output of either the LUT 720 or the carry logic 730, while the multiplexer 745 can be used to select another output of the LUT 720 or the multiplexer 740. In some examples, the multiplexer is used to either select a sequential output of a state element (e.g. flip-flop 750), or a combinational output of a Look Up Table. It should be readily understood to one of ordinary skill in the art having the benefit of the present disclosure that different logic functions, LUT sizes, and sequential elements can be employed in a reconfigurable logic element. Thus, techniques for mapping neural networks to such reconfigurable logic can vary depending on the specific target FPGA architecture. The configuration of the logic inside the reconfigurable logic block can be programmed using the configuration port of the FPGA. In some examples, the LUTs are not programmed once, but can be configured to act as small memories that store certain data used in the neural network.

In some examples of the disclosed technology, a logic synthesis tool (logic compiler) is used to transform a specification for a neural network model or subgraph into a configuration bitstream that can be applied to a configuration port of an FPGA to configure logic to implement the multiprocessor 100 or portions of a neural network. In some examples, the designer can use an RPM (relationally placed macro) methodology to improve area and interconnect delays and achieve a repeatable layout for easy routing and timing closure under module composition and massive replication. For example, by including structural RTL instantiating modules and tiling them into a scheduler, logic for the instruction scheduler can be locked to a set of single LUTs, allow for a compact clustering and placement of logic within the FPGA.

### IX. Example Neural Network Accelerator API

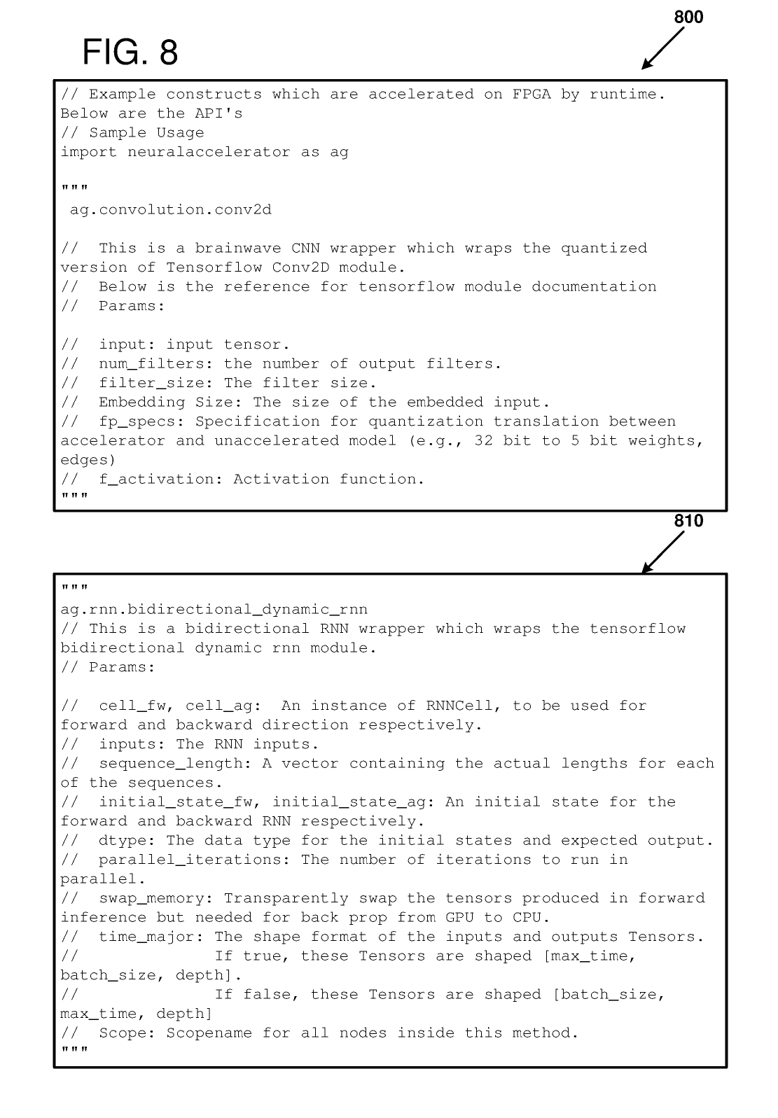

FIGS. 8-10 provide example pseudo-code for predefined APIs that can be used to specify interface connections between a neural network model and an accelerated subgraph. For example, a compiler can support a set of predefined APIs that implement different subgraphs that can be accelerated on the neural network accelerator. The predefined APIs can be modeled on other APIs, such as APIs used for a native framework (e.g., TensorFlow). For example, the predefined APIs can have a similar interface to the APIs of the native framework. The predefined APIs can include implementing code that is written in the native framework. Thus, the predefined APIs can replace one or more APIs of the native framework and can be evaluated using the native framework. As described above regarding FIGS. 5A and 5B, implementing code of the predefined APIs can include marker nodes and/or quantization nodes. The marker nodes in the quantization nodes can be used to model and effect of the accelerator while executing the predefined APIs in the native framework.

The compiler can use source code of the native framework, where the source code specifies an architecture of a neural network model and the source code includes a mixture of APIs of the native framework and predefined APIs representing subgraphs that can be accelerated. The compiler can analyze the source code to generate compiled executable code and/or configuration data so that the neural network model can be evaluated on a platform including a general-purpose CPU and a neural network accelerator.

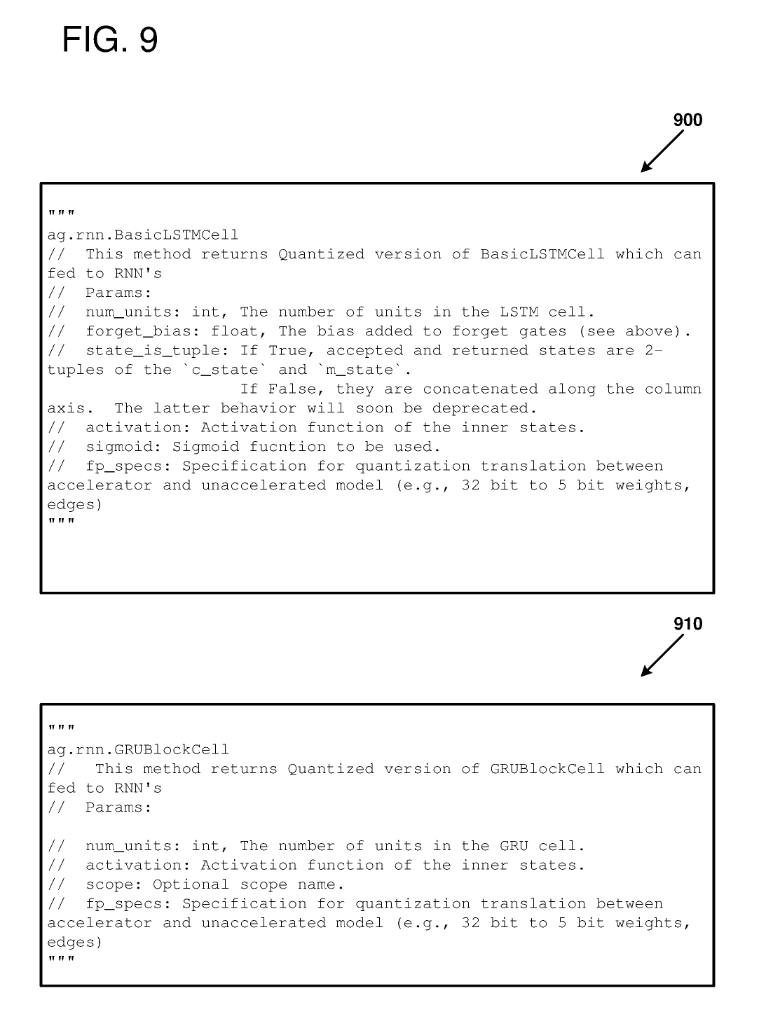

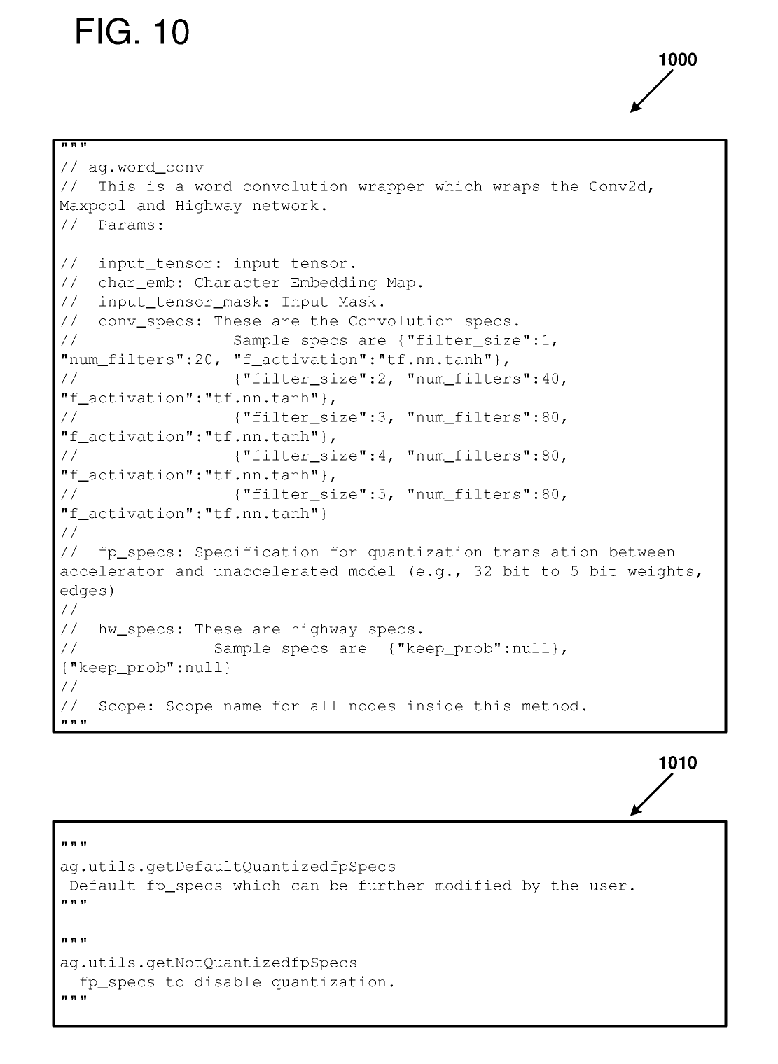

Turning to FIG. 8, a first code portion 800 is a convolutional neural network (CNN) wrapper that wraps a quantized version of a tensor flow module, as can be implemented in certain examples of the disclosed technology. A second code portion 810 provides an interface for a bidirectional recurrent neural network (RNN) wrapper that can be used to wrap the tensor flow to a bidirectional dynamic RNN module. In FIG. 9, a third code portion 900 is a method that returns a quantized version of a basic long short-term memory (LSTM) cell that can be fed to an RNN. A fourth code portion 910 is a method that returns a quantized version of the GRU block cell that can be fed to RNNs. In FIG. 10, a fifth code portion 1000 provides a word convolution wrapper, as can be used in certain examples of the disclosed technology. A sixth code portion 1010 includes an example interface that can be used to define or disable quantization specifications for converting numeric formats between the neural network model 310 and subgraph 320. For example, the quantization specifications can be disabled during initial training and/or when the neural network model is to be evaluated without the neural network accelerator. The quantization specifications can be enabled when fine tuning the training and/or when simulating how the neural network accelerator will affect an evaluation of the neural network model, such as prior to deployment on the neural network accelerator.

### X. Example Methods of Using a Neural Network Server and Accelerator

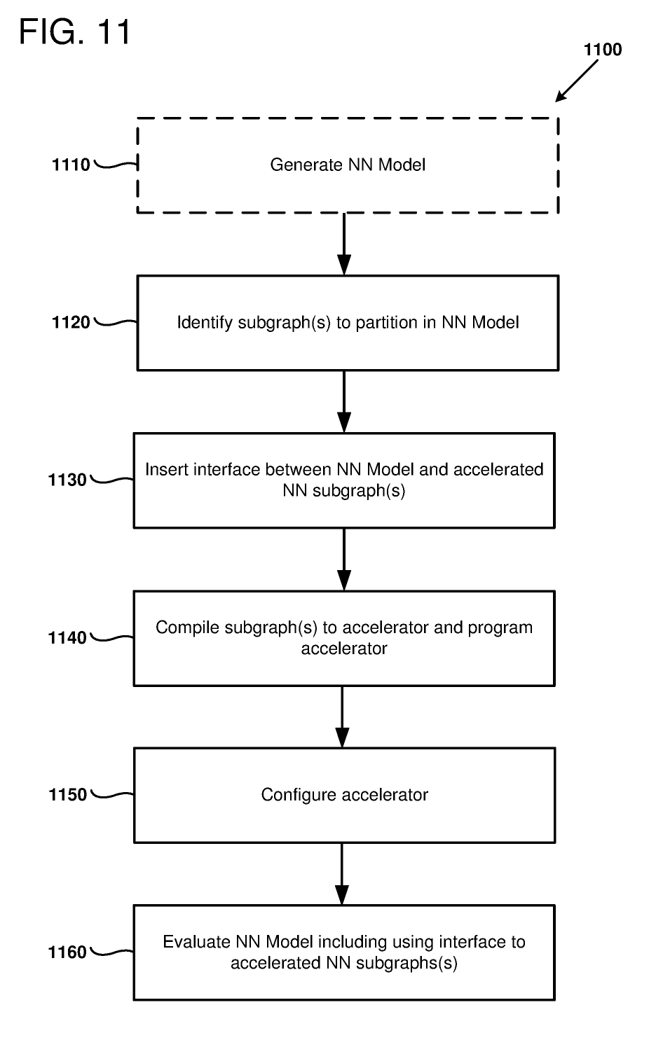

FIG. 11 is a flow chart 1100 outlining an example method of using a partitioned neural network model, as can be performed in certain examples of the disclosed technology. For example, the illustrated method can be implemented using the neural network server 410 and neural network accelerator 450 discussed above. One or more of the process blocks can be performed by tools of a tool flow, such as the tools 420, 430, and 440 discussed above.

At process block 1110, a neural network model is generated. In some examples, a neural network may be provided in a data file. For example, the data file can specify a number of layers of the neural network, a number of nodes (e.g., neurons) within a layer, activation functions for the neural nodes, training weights, and so forth. In other examples, a programming language is used to specify the neural network model, such as a source code file that is compatible with a native framework. APIs can be developed for the native framework using the programming language so that complex neural networks can be generated by instantiating the APIs within a particular model. Data structures on a neural network server can be initialized with values specified in the data file or in the programming language. In some examples, initializing the neural network may include training the neural network using a training set for an objective function for converting the neural network to produce a specified output.

A particular neural network model can be implemented on different computing platforms having different properties. For example, a first implementation of the model can be executed using a machine learning execution engine on a non-accelerated server. A second implementation can be executed using the neural network server 410 and neural network accelerator 450. Differences in underlying hardware (such as a precision of the NN calculations) may yield slightly different results when the same neural network model is executed on different machines. As one example, the neural network accelerator 450 may model subgraphs using a fewer number of bits than the non-accelerated server.

A single source code specification of the neural network model can provide information for implementing and/or simulating the neural network model on different computing platforms. For example, the neural network model can include multiple subgraphs, where at least one of the subgraphs can be accelerated. Each of the subgraphs can be specified using an API corresponding to the subgraph. Implementing code of the APIs for the subgraphs that can be accelerated can include marker nodes and/or quantization nodes in addition to the neural nodes of the subgraph. For example, the marker nodes can be used to mark a boundary of the subgraph. The marker nodes can include interface information for communicating between a general-purpose CPU and the neural network accelerator. The marker nodes can include quantization information so that a change in precision of the underlying hardware can be properly accounted for. The marker nodes can include conditional logic so that the marker nodes perform different functions depending on a phase of use of the neural network model. For example, the different phases can include initial training, final training, compilation, evaluation using only a general-purpose CPU, and evaluation using a general-purpose CPU and a neural network accelerator.

At process block 1120, at least one subgraph is identified to partition in the neural network model. For example, portions of the neural network model that are heavily used, that would benefit from quantization, that have reduced latency requirements, have a lower number of edges to the subgraph, or other techniques can be used to identify suitable subgraphs to partition. In some examples, the compiler analyzes the neural network model generated at process block 1110 to identify a subgraph. In this case, the compiler can insert marker nodes into the source code to mark a boundary of the subgraph identified to be partitioned. The compiler can also insert quantization nodes between internal nodes of the subgraph within the source code. In other examples, the subgraph may be explicitly identified by a user, for example by coding in a programming language, selecting a particular API, adding marker nodes, or otherwise identifying edges and/or neural nodes that will become part of the subgraph. Predefined APIs can include marker nodes at the interface of the subgraph. As one example, the marker nodes can be used by the compiler to identify subgraphs for acceleration. The marker nodes can be specified in a language supported by the native framework. Functions that are performed by the native framework (such as changing a precision of a computation) can be specified using the language primitives of the native framework. Information that is passed to other tools, such as the compiler, can be specified using comments of the native framework and/or naming conventions of APIs.

At process block 1130, an interface is inserted between the neural network model and its subgraph. The interface can provide seamless communication between the neural network model and a subgraph by, for example, transparently mapping memory operations based on an identifier to a corresponding location at the hardware accelerator. For example, the interface can include executable code for communicating information (e.g., subgraph inputs and outputs) between the server and the accelerator. The interface can also perform transformation operations, such as transforming numeric formats to a quantized format used on the accelerator. In some examples, a PCI-Express (also referred to as PCIe) bus is used to couple a general-purpose processor to an interface port of a neural hardware accelerator and send messages therebetween.

At process block 1140, the subgraph is compiled to the accelerator. For example, values that will be stored in RAM, such as weights, biases, and tensor values can be generated by the compiler and assigned to a particular RAM of the accelerator. The compiler can generate support logic such as packet encoders/decoders and scheduling logic for implementation on the accelerator. Further, the compiler can generate logic that implements rules for updating node values for the neural network implemented on the hardware accelerator. As a specific example, the compiler can generate a configuration bitstream to program the configurable logic to perform the functions of the respective neural nodes and of the subgraph. As another example, the compiler can generate executable code or microcode that can be executed by a hard or soft CPU of the accelerator to perform the functions of the respective neural nodes and of the subgraph.

At process block 1150, the accelerator is configured to implement the subgraph using configuration information generated at process block 1140. For example, an FPGA bitstream may be generated by the compiler that is then used to program at least a portion of the FPGA's configuration logic to implement the subgraph. The configuration may also include implementation of a soft CPU, or supervisor logic providing the interfaces between the model and the accelerator. Additionally, the runtime module can load weights and biases from training into the memories of the accelerator.

At process block 1160, the neural network model is evaluated, including using the provided interface between the accelerated neural network subgraphs. The runtime module can be used to control evaluation and monitoring of data as it passes between the neural network model implemented on a server and a subgraph that is provided by the hardware accelerator.

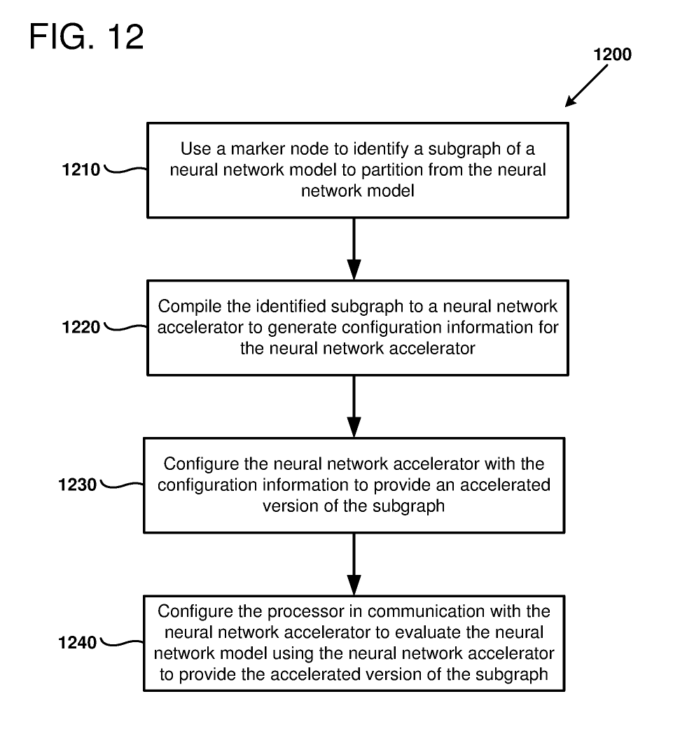

FIG. 12 is a flow chart outlining an example method 1200 of using a neural network model, as can be performed in certain examples of the disclosed technology. For example, the illustrated method can be implemented using the tools 420, 430, and 440 executing on the neural network server 410 discussed above regarding FIG. 4. A computer-readable memory can be used to store computer-executable instructions that when executed by a processor (e.g., CPU 411), cause the processor to perform the method 1200.

At process block 1210, a marker node can be used to identify a subgraph of the neural network model to partition from the neural network model. The subgraph can be partitioned and implemented on a neural network accelerator to potentially increase a processing speed for evaluating the neural network model. For example, the compiler can analyze the source code used to define the neural network model (and the subgraph). The subgraph of the neural network model can be identified as the neural nodes that are located within a boundary that is defined using marker nodes. As one example, a first marker node can be connected to one or more input edges of the subgraph and a second marker node can be connected to one or more output edges of the subgraph. The marker nodes and the subgraph can be incorporated within implementing code of an API. For example, a software development toolkit for a machine learning modelling framework (also referred to as a native framework) can include a library of APIs that are modeled after predefined neural networks that are capable of being accelerated as subgraphs. The predefined neural networks can include neural networks such as bidirectional RNNs with LSTM or GRU block cells. Thus, the source code specifying the neural network model can call the APIs to add subgraphs capable of acceleration to the neural network model.

In addition to identifying the subgraph of the neural network model for acceleration, the marker nodes can provide additional functionality. Specifically, the marker nodes can perform different functions during different phases of use of the neural network model. The different phases can include initial or early training, later training, compilation, evaluation using the accelerator, and evaluation without using the accelerator. The marker nodes can be implemented to take advantage of and/or model differences in the processor and accelerator functionalities. For example, the processor can be configured to perform computations at a higher precision than a neural network accelerator. The marker node can pass values unchanged between the identified subgraph and the neural network model during an initial training mode implemented on the machine learning native framework executing on the processor. The marker node can reduce a precision of values passed as inputs to the identified subgraph during a fine-tune training mode implemented on the machine learning native framework executing on the processor. The marker node can reduce a precision of values output from the identified subgraph during a fine-tune training mode implemented on the machine learning native framework executing on the processor. The marker node can include metadata specifying a format for communicating values between the accelerated version of the subgraph and the neural network model executing on the processor in communication with the neural network accelerator. The identified subgraph can include a quantization node interposed between a first internal neural node of the subgraph and a second internal neural node of the subgraph. The quantization node can reduce a precision of values passed between the first internal neural node and the second internal neural node during a fine-tune training mode implemented on the machine learning native framework executing on the processor.

At process block 1220, the identified subgraph can be compiled to the neural network accelerator to generate configuration information for the neural network accelerator. Compiling the identified subgraph can include assigning training data to particular memory elements of the neural network accelerator. For example, the particular memory elements can be block RAMs or register files. The training data can include weights and biases corresponding to nodes of the identified subgraph. Compiling the identified subgraph can include assigning a particular region of configurable logic of the neural network accelerator to evaluate a particular neural node of the identified subgraph. For example, one region of configurable logic can be configured to be a first neural node processor element, a different region of configurable logic can be configured to be a second neural node processor element, and so forth. Compiling the identified subgraph can include generating routing logic for communicating values between the neural node processor elements. Compiling the identified subgraph can include assigning training data corresponding to the particular node of the subgraph to a memory element that is locally accessible to the particular region of configurable logic of the neural network accelerator.

Compiling the identified subgraph can also include generating support logic for moving data into and out of the identified subgraph and for scheduling operations of the identified subgraph. For example, the support logic can include logic for decoding packets of tensor values sent from the server, logic for broadcasting the tensor values to memory elements corresponding to the respective nodes of the subgraph, logic for gathering the tensor values from memory elements corresponding to the respective nodes of the subgraph, logic for encoding the gathered tensor values from the subgraph into a packet that can be sent to the server, logic for scheduling operations of the respective nodes of the subgraph, and so forth.

Compiling the identified subgraph can include generating a configuration bitstream for programming configurable hardware, generating executable code or microcode to run on the server and/or the accelerator (such as a hard or soft CPU), and generating data structures storing training data (e.g., weights and biases) and/or other operational characteristics (such as parameters of an activation function).

At process block 1230, the neural network accelerator can be configured with the configuration information to provide an accelerated version of the subgraph. For example, a configuration bitstream can be applied to the configurable hardware of the neural network accelerator, executable code and/or microcode can be loaded onto memories accessible by a hard or soft CPU, and training data and operational characteristics can be loaded onto memory elements of the neural network accelerator.

At process block 1240, the processor in communication with the neural network accelerator can be configured to evaluate the neural network model using the neural network accelerator to provide the accelerated version of the subgraph. For example, the processor can be configured to evaluate portions of the neural network model external to the subgraph. Values generated by the neural network model can be passed to the subgraph using a communication channel between the processor and the neural network accelerator. Similarly, values generated by the subgraph can be passed to the neural network model using a communication channel between the neural network accelerator and the processor. As one example, the values can be passed using a message or packet formatted according to a data structure for passing tensor values between the subgraph and the neural network model.

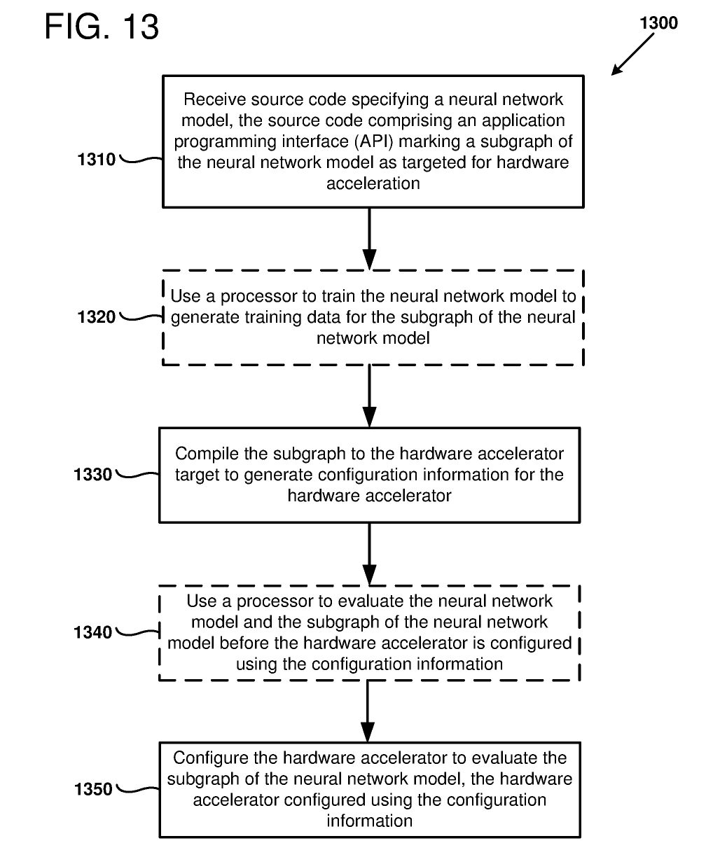

FIG. 13 is a flow chart outlining an example method 1300 of using a neural network model, as can be performed in certain examples of the disclosed technology. For example, the illustrated method can be implemented using the neural network server 410 and neural network accelerator 450 discussed above regarding FIG. 4. One or more of the process blocks can be performed by the tools 420, 430, and 440 executing on the neural network server 410. A computer-readable memory can be used to store computer-executable instructions that when executed by a processor (e.g., CPU 411), cause the processor to perform the method 1300.

At process block 1310, source code specifying a neural network model can be received. The source code can include an application programming interface (API) marking a subgraph of the neural network model as targeted for hardware acceleration. For example, the source code can include calling or declaring code of the API for instantiating the subgraph. Implementing code of the API can specify the architecture of the subgraph and can include additional information for marking the subgraph and/or using the subgraph. For example, the implementing code of the API can include a marker node at a boundary of the subgraph and a quantization node between internal neural nodes of the subgraph.

At process block 1320, a processor can optionally be used to train the neural network model to generate training data for the subgraph of the neural network model. The processor can be configured to perform computations at a higher precision than the hardware accelerator. The training can include multiple phases, where a first phase uses the higher precision of the processor for calculating training data (e.g., weights and/or biases) of the subgraph, and a second phase uses the lower precision of the accelerator for calculating the training data of the subgraph. The marker nodes and quantization nodes can be used perform conversions of precision when the training takes place on the processor. Specifically, the marker node can pass a value unchanged from the neural node model to the subgraph during the first phase of the training. The marker node can convert a value from the higher precision of the processor to the lower precision of the hardware accelerator when the value is passed from the neural node model to the subgraph during the second phase of the training. The implementing code of the API can include a quantization node between a first internal neural node and a second internal neural node of the subgraph, and the quantization node can convert a value from the higher precision of the processor to the lower precision of the hardware accelerator when the value is generated by the first internal neural node and passed to second internal neural node during a second phase of the training. The quantization node can pass the value unchanged during the first phase of the training. An output of the training is the training data of the individual neural nodes of the subgraph and of the neural network model.

At process block 1330, the subgraph can be compiled to the hardware accelerator target to generate configuration information for the hardware accelerator. The configuration information can be used to program resources of the hardware accelerator to perform the operations of the subgraph. The resources can include configurable logic blocks, programmable routing interconnect, memory elements, and a hard or soft CPU. The configuration information can include information to program the hard or soft CPU, program the configurable logic blocks to perform a particular function, program the routing interconnect to connect the different resources of the accelerator, and/or store training data into memory elements of the resources.

At process block 1340, the processor can optionally be used to evaluate the neural network model and the subgraph of the neural network model before the hardware accelerator is configured using the configuration information. Even though the processor uses a higher precision than the accelerator, the marker nodes and quantization nodes can be used to convert a precision of calculations from the processor to the precision of the accelerator for the subgraph calculations. Thus, the subgraph can be executed on the processor and an affect of the reduced precision of the accelerator can be simulated.

At process block 1350, the hardware accelerator can be configured to evaluate the subgraph of the neural network model, where the hardware accelerator is configured using the configuration information. For example, the resources of the accelerator can be configured by a deployment tool so that the accelerator is configured to evaluate the subgraph of the neural network model. The configuration can persist on the resources of the accelerator for the duration of an evaluation of the neural network model. By having the subgraph configuration persist on the resources throughout the evaluation of the neural network model, a processing speed of the system can potentially be increased compared to reconfiguring the subgraph at various times during the evaluation of the model. Configuring the resources can include loading code for execution by a hard or soft CPU, programming configurable logic blocks to perform a particular function, programming routing interconnect to connect the different resources, and loading training data into memory elements of the resources.

### XI. Example Computing Environment

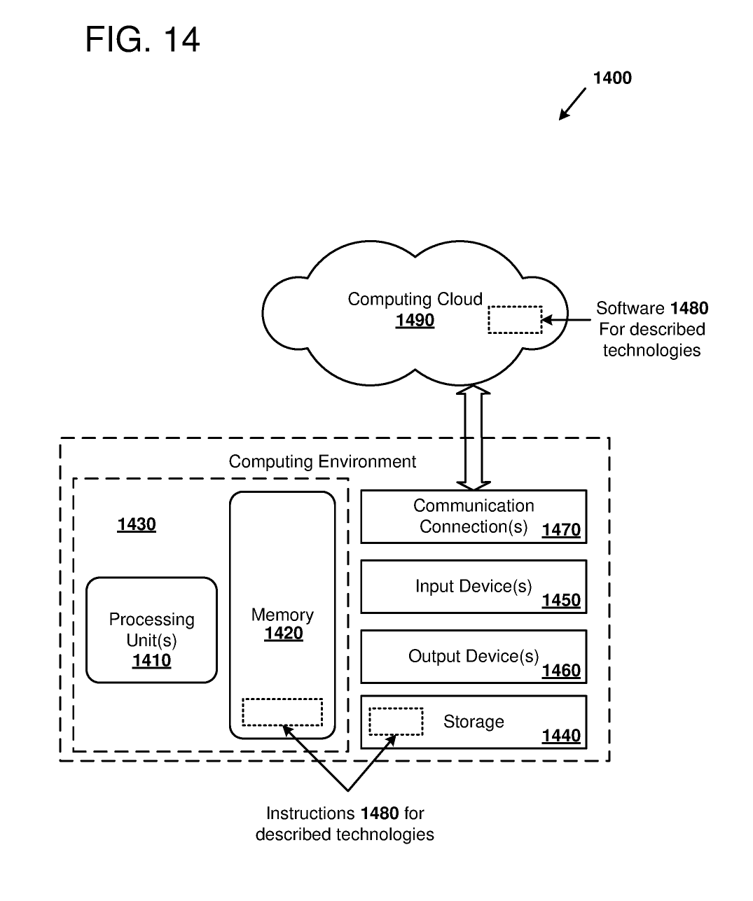

FIG. 14 illustrates a generalized example of a suitable computing environment 1400 in which described embodiments, techniques, and technologies, including configuring a multiprocessor, can be implemented. For example, the computing environment 1400 can implement disclosed techniques for configuring a processor to implement disclosed multiprocessor architectures and neural networks, and/or compile code into computer-executable instructions and/or configuration bitstreams for performing such operations including neural networks, as described herein.

The computing environment 1400 is not intended to suggest any limitation as to scope of use or functionality of the technology, as the technology may be implemented in diverse general-purpose or special-purpose computing environments. For example, the disclosed technology may be implemented with other computer system configurations, including hand held devices, multi-processor systems, programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

With reference to FIG. 14, the computing environment 1400 includes at least one processing unit 1410 and memory 1420. In FIG. 14, this most basic configuration 1430 is included within a dashed line. The processing unit 1410 executes computer-executable instructions and may be a real or a virtual processor. In a multi-processing system, multiple processing units execute computer-executable instructions to increase processing power and as such, multiple processors can be running simultaneously. The memory 1420 may be volatile memory (e.g., registers, cache, RAM), non-volatile memory (e.g., ROM, EEPROM, flash memory, etc.), or some combination of the two. The memory 1420 stores software 1480, images, and video that can, for example, implement the technologies described herein. A computing environment may have additional features. For example, the computing environment 1400 includes storage 1440, one or more input device(s) 1450, one or more output device(s) 1460, and one or more communication connection(s) 1470. An interconnection mechanism (not shown) such as a bus, a controller, or a network, interconnects the components of the computing environment 1400. Typically, operating system software (not shown) provides an operating environment for other software executing in the computing environment 1400, and coordinates activities of the components of the computing environment 1400.

The storage 1440 may be removable or non-removable, and includes magnetic disks, magnetic tapes or cassettes, CD-ROMs, CD-RWs, DVDs, or any other medium which can be used to store information and that can be accessed within the computing environment 1400. The storage 1440 stores instructions for the software 1480, which can be used to implement technologies described herein.

The input device(s) 1450 may be a touch input device, such as a keyboard, keypad, mouse, touch screen display, pen, or trackball, a voice input device, a scanning device, or another device, that provides input to the computing environment 1400. For audio, the input device(s) 1450 may be a sound card or similar device that accepts audio input in analog or digital form, or a CD-ROM reader that provides audio samples to the computing environment 1400. The output device(s) 1460 may be a display, printer, speaker, CD-writer, or another device that provides output from the computing environment 1400.

The communication connection(s) 1470 enable communication over a communication medium (e.g., a connecting network) to another computing entity. The communication medium conveys information such as computer-executable instructions, compressed graphics information, video, or other data in a modulated data signal. The communication connection(s) 1470 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed methods. In a virtual host environment, the communication(s) connections can be a virtualized network connection provided by the virtual host.

Some embodiments of the disclosed methods can be performed using computer-executable instructions implementing all or a portion of the disclosed technology in a computing cloud 1490. For example, disclosed compilers, processors, and/or neural networks are implemented with servers located in the computing environment, or the disclosed compilers, processors, and/or neural networks can be implemented on servers located in the computing cloud 1490. In some examples, the disclosed compilers execute on traditional central processing units (e.g., RISC or CISC processors), central processing units extended to include vector processing instructions, or vector processors.

Computer-readable media are any available media that can be accessed within a computing environment 1400. By way of example, and not limitation, with the computing environment 1400, computer-readable media include memory 1420 and/or storage 1440. As should be readily understood, the term computer-readable storage media includes the media for data storage such as memory 1420 and storage 1440, and not transmission media such as modulated data signals.

### XII. Additional Examples of the Disclosed Technology

Additional examples of the disclosed subject matter are discussed herein in accordance with the examples discussed above.

In one embodiment, a computer-readable memory stores computer-executable instructions that when executed by a processor, cause the processor to perform a method. The method includes using a marker node to identify a subgraph of a neural network model to partition from the neural network model. The marker node is located at a boundary of the subgraph. The identified subgraph is compiled to a neural network accelerator. The compiler generates configuration information for the neural network accelerator. The configuration information can include training data, where the training data of the subgraph is generated using higher precision computations during early training and lower precision computations during later training. The neural network accelerator is configured with the configuration information to provide an accelerated version of the subgraph. The processor in communication with the neural network accelerator is configured to evaluate the neural network model using the neural network accelerator to provide the accelerated version of the subgraph.

The processor can be configured to perform computations at a higher precision than the neural network accelerator. The neural network model can be specified using source code of a machine learning native framework. For example, the marker node is located in implementing code of an application programming interface defining the identified subgraph. The marker node can pass values unchanged between the identified subgraph and the neural network model during an initial training mode implemented on the machine learning native framework executing on the processor. The marker node can reduce a precision of values passed as inputs to the identified subgraph during a fine-tune training mode implemented on the machine learning native framework executing on the processor. The marker node can reduce a precision of values output from the identified subgraph during a fine-tune training mode implemented on the machine learning native framework executing on the processor. The marker node can include metadata specifying a format for communicating values between the accelerated version of the subgraph and the neural network model executing on the processor in communication with the neural network accelerator. The identified subgraph can include a quantization node interposed between a first internal neural node of the subgraph and a second internal neural node of the subgraph. The quantization node can reduce a precision of values passed between the first internal neural node and the second internal neural node during a fine-tune training mode implemented on the machine learning native framework executing on the processor.

In one embodiment, a method includes receiving source code specifying a neural network model. The source code includes a programming interface marking a subgraph of the neural network model as targeted for hardware acceleration. The method includes compiling the subgraph to the neural network accelerator target to generate configuration information for the hardware accelerator. The method includes configuring the hardware accelerator to evaluate the neural network model, the hardware accelerator configured using the configuration information. The method can further include using a processor to train the neural network model to generate training data for the subgraph of the neural network model, where the processor is configured to perform computations at a higher precision than the hardware accelerator. The method can further include using a processor to evaluate the neural network model and the subgraph of the neural network model before the hardware accelerator is configured using the configuration information. For example, the processor can be configured to convert computations of the subgraph from a higher precision of the processor to a lower precision of the hardware accelerator during the evaluation by the processor.

The programming interface can be an application programming interface (API). Implementing code of the programming interface can include a marker node at a boundary of the subgraph, and the marker node can pass a value unchanged from the neural node model to the subgraph during a first phase of the training. The marker node can convert a value from the higher precision of the processor to the lower precision of the hardware accelerator when the value is passed from the neural node model to the subgraph during a second phase of the training. The implementing code of the programming interface can include a quantization node between a first internal neural node and a second internal neural node of the subgraph. The quantization node can convert a value from the higher precision of the processor to the lower precision of the hardware accelerator when the value is generated by the first internal neural node and passed to second internal neural node during a second phase of the training.

In one embodiment, a system includes a neural network server in communication with a neural network accelerator. The neural network server includes at least one processor, and the at least one processor is configured to perform computations at a higher precision than the neural network accelerator. The neural network server includes a computer-readable memory storing computer-executable instructions that when executed by the at least one processor, cause the neural network server to perform a method. The instructions include instructions to compile a neural network model for execution on the system. The neural network model is specified using source code including an application programming interface (API) marking a subgraph of the neural network model as targeted for the neural network accelerator. An output of compilation is configuration data for configuring the neural network accelerator. The instructions include instructions to configure the neural network accelerator to evaluate the neural network model. The neural network accelerator includes configurable logic that is configurable using at least the generated configuration data. The configurable logic includes a plurality of regions, where a respective region is configured to perform an operation of a respective node of the subgraph. The neural network accelerator includes memory including a plurality of memory elements, where a respective memory element is locally accessible by a respective region of the configurable logic.

A boundary of the subgraph can be marked using marker nodes and compiling the neural network model can include identifying all of the marker nodes at the boundary of the subgraph. Compiling the neural network model can include assigning training data of respective neural nodes of the subgraph to respective memory elements of the neural network accelerator. The training data can be generated by using calculations of multiple precisions for the computations of the subgraph during training of the neural network model.

In view of the many possible embodiments to which the principles of the disclosed subject matter may be applied, it should be recognized that the illustrated embodiments are only preferred examples and should not be taken as limiting the scope of the claims to those preferred examples. Rather, the scope of the claimed subject matter is defined by the following claims. We therefore claim as our invention all that comes within the scope of these claims.

What is claimed is:

1. A computer-readable memory storing computer-executable instructions that when executed by a processor, cause the processor to perform a method, the method comprising:
using a marker node to identify a subgraph of a neural network model to partition from the neural network model, the marker node located at a boundary of the subgraph;
compiling the identified subgraph to a neural network accelerator to generate configuration information for the neural network accelerator;
configuring the neural network accelerator with the configuration information to provide an accelerated version of the subgraph; and
configuring the processor in communication with the neural network accelerator to evaluate the neural network model using the neural network accelerator to provide the accelerated version of the subgraph.

2. The computer-readable memory of claim 1, wherein the processor is configured to perform computations at a higher precision than the neural network accelerator.

3. The computer-readable memory of claim 1, wherein the neural network model is specified using source code of a machine learning native framework.

4. The computer-readable memory of claim 1, wherein the marker node reduces a precision of values passed to the identified subgraph during a fine-tune training mode implemented on the machine learning native framework executing on the processor.

5. The computer-readable memory of claim 1, wherein the marker node reduces a precision of values output from the identified subgraph during a fine-tune training mode implemented on the machine learning native framework executing on the processor.

6. The computer-readable memory of claim 1, wherein the marker node passes values unchanged between the identified subgraph and the neural network model during an initial training mode implemented on the machine learning native framework executing on the processor.

7. The computer-readable memory of claim 1, wherein the identified subgraph comprises a quantization node interposed between a first internal neural node of the subgraph and a second internal neural node of the subgraph, and the quantization node reduces a precision of values passed between the first internal neural node and the second internal neural node during a fine-tune training mode implemented on the machine learning native framework executing on the processor.

8. The computer-readable memory of claim 1, wherein the marker node comprises metadata specifying a format for communicating values between the accelerated version of the subgraph and the neural network model executing on the processor in communication with the neural network accelerator.

9. The computer-readable memory of claim 1, wherein the configuration information comprises training data, and the training data of the subgraph is generated using higher precision computations during early training and lower precision computations during later training.

10. A method comprising:
receiving source code specifying a neural network model, the source code comprising a programming interface marking a subgraph of the neural network model as targeted for hardware acceleration;
compiling the subgraph to the hardware accelerator target to generate configuration information for the hardware accelerator;
configuring the hardware accelerator to evaluate the subgraph of the neural network model, the hardware accelerator configured using the configuration information.

11. The method of claim 10, wherein the programming interface is an application programming interface (API).

12. The method of claim 10, further comprising:
using a processor to train the neural network model to generate training data for the subgraph of the neural network model, the processor configured to perform computations at a higher precision than the hardware accelerator;

13. The method of claim 12, wherein implementing code of the programming interface comprises a marker node at a boundary of the subgraph, and the marker node passes a value unchanged from the neural node model to the subgraph during a first phase of the training.

14. The method of claim 12, wherein implementing code of the programming interface comprises a marker node at a boundary of the subgraph, and the marker node converts a value from the higher precision of the processor to the lower precision of the hardware accelerator when the value is passed from the neural node model to the subgraph during a second phase of the training.

15. The method of claim 12, wherein implementing code of the programming interface comprises a quantization node between a first internal neural node and a second internal neural node of the subgraph, and the quantization node converts a value from the higher precision of the processor to the lower precision of the hardware accelerator when the value is generated by the first internal neural node and passed to second internal neural node during a second phase of the training.

16. The method of claim 11, further comprising:
using a processor to evaluate the neural network model and the subgraph of the neural network model before the hardware accelerator is configured using the configuration information, the processor configured to convert computations of the subgraph from a higher precision of the processor to a lower precision of the hardware accelerator during the evaluation by the processor;

17. A system, comprising:
a neural network server in communication with a neural network accelerator, the neural network server comprising:
at least one processor, the at least one processor configured to perform computations at a higher precision than the neural network accelerator, and
a computer-readable memory storing computer-executable instructions that when executed by the at least one processor, cause the neural network server to perform a method, the instructions comprising:
instructions to compile a neural network model for execution on the system, wherein the neural network model is specified using source code comprising an application programming interface (API) marking a subgraph of the neural network model as targeted for the neural network accelerator, and an output of compilation is configuration data for configuring the neural network accelerator; and
instructions to configure the neural network accelerator to evaluate the neural network model; and
wherein the neural network accelerator comprises:
configurable logic that is configurable using at least the generated configuration data, the configurable logic comprising a plurality of regions, a respective region configured to perform an operation of a respective node of the subgraph; and
memory comprising a plurality of memory elements, wherein a respective memory element is locally accessible by a respective region of the configurable logic.

18. The system of claim 17, wherein a boundary of the subgraph is marked using marker nodes and compiling the neural network model comprises identifying all of the marker nodes at the boundary of the subgraph.

19. The system of claim 17, wherein compiling the neural network model comprises assigning training data of respective neural nodes of the subgraph to respective memory elements of the neural network accelerator.

20. The system of claim 17, wherein the training data is generated by using calculations of multiple precisions for the computations of the subgraph during training of the neural network model.
